(19) United States
(12) Patent Application Publication
(10) Pub. No.: US 2018/0221951 A1
(43) Pub. Date: Aug. 9, 2018

(54) SINTERED BODY FOR FORMING A RARE-EARTH MAGNET AND RARE-EARTH SINTERED MAGNET

(71) Applicant: NITTO DENKO CORPORATION, Ibaraki-shi, Osaka (JP)

(72) Inventors: Kenichi FUJIKAWA, Ibaraki-shi (JP); Izumi OZEKI, Ibaraki-shi (JP); Tomohiro OMURE, Ibaraki-shi (JP); Miho YAMAGUCHI, Ibaraki-shi (JP); Toshiaki OKUNO, Ibaraki-shi (JP); Hiroshi MATSUO, Ibaraki-shi (JP)

(73) Assignee: NITTO DENKO CORPORATION, Ibaraki-shi, Osaka (JP)

(21) Appl. No.: 15/749,129

(22) PCT Filed: Jul. 29, 2016
(86) PCT No.: PCT/JP2016/072392

§ 371 Date: Jan. 31, 2018

(30) Foreign Application Priority Data
Jul. 31, 2015 (JP) 2015-151762

(51) Int. Cl. B22F 3/10; C22C 38/00; H01F 1/055; H01F 1/08; H01F 7/02

(52) U.S. Cl. CPC B22F 3/1017; C22C 38/00; H01F 7/02; H01F 1/086; H01F 1/055

(57) ABSTRACT

Provided is a heretofore non-existing, novel rare-earth sintered magnet having both of an extremely low carbon content and an extremely small average particle size of magnet material particles. The sintered body for forming a rare-earth magnet comprises a large number of magnet material particles sintered together, wherein each of the magnet material particles contains a rare-earth substance and has an easy magnetization axis. This sintered body for forming a rare-earth magnet has a carbon content of 500 ppm or less, and the magnet material particles have an average particle size of 2 μm or less.

### TECHNICAL FIELD

The present invention relates to a sintered body for forming a rare-earth magnet for forming a rare-earth sintered magnet, and a rare-earth sintered magnet obtained by magnetizing the sintered body. In particular, the present invention relates to a sintered body for forming a rare-earth magnet comprising a large number of magnet material particles sintered together, wherein each of the magnet material particles contains a rare-earth substance and has an easy magnetization axis, and wherein the sintered body is capable of exhibiting high coercivity (coercive force) and having a zone in which easy magnetization axes are oriented in non-parallel relation to each other. The present invention also relates to a rare-earth sintered magnet obtained by magnetizing the sintered body.

### BACKGROUND ART

A rare-earth sintered magnet has been regarded as a high performance permanent magnet having potential to realize high coercivity and residual flux density, and, along with commercialization, development toward higher performance is being actively conducted. For example, in the research paper: Yasuhiro UNE, et al., “Achievement of high coercivity in Nd—Fe—B sintered magnet by crystal grain refinement”, Journal of the Japan Institute of Metals and Materials, Vol. 76, No. 1 (2012), pp 12 to 16 (Non-Patent Document 1), there is described an example in which a rare-earth sintered magnet is produced using magnet-forming material particles having an average powder particle size of 1 μm to achieve high coercivity in a Nd—Fe—B based sintered magnet, under the knowledge that, although it is well-known that as a particle size of a magnet material is set to a smaller value, the coercivity of a resulting magnet becomes higher, a decline in the coercivity is observed when an average powder particle size is reduced to less than 2.7 μm, and this is considered to be caused by some sort of abnormality occurring in a powder or a sintered body. In the rare-earth sintered magnet production method described in the Non-Patent Document 1, a mixture obtained by mixing magnet material particles and a lubricant comprised of a surfactant together is filled in a carbon mold, then the mold is fixed inside an air-core coil, and a pulsed magnetic field is applied thereto to thereby orient the magnet material particles. There are also described a sintered body having an average powder particle size of 1.1 μm and containing oxygen in an amount of 1460 ppm, nitrogen in an amount of 150 ppm and carbon in an amount of of 1200 ppm and other sintered bodies, as examples of a low-pollution sintered body which could be prepared by an experimental device used in a sintered body preparation step described in the Non-Patent Document 1.

Further, in the research paper: T. Minowa, et al., “Microstructure of Nd-rich phase in Nd—Fe—B magnet containing oxygen and carbon impurities”, Journal of Magnetism and Magnetic Material, Vol. 97 (1991), pp 107 to 111 (Non-Patent Document 2), there are described: an experiment in which, assuming that properties of a Nd—Fe—B based magnet is significantly influenced by oxygen and carbon as impurity elements, the dependency of intrinsic coercivity of a Nd—Fe—B based magnet on carbon and oxygen contents was observed using Nd—Fe—B based magnets added with impurities; and a finding from the experiment that, while both of the impurities cause a decline in the coercivity, carbon has a negative influence greater than that of oxygen.

With regard to influences of carbon, oxygen and nitrogen contents on performance of an R—Fe—B based (where R is a rare-earth element including Y) sintered permanent magnet including a Nd—Fe—B based sintered magnet, in JP 3586577 B (Patent Document 1), there is described a technique intended to significantly improve corrosion resistance of the R—Fe—B based sintered permanent magnet, based on recognition of a problem that the R—Fe—B based sintered permanent magnet is inferior to a Sm—Co based sintered permanent magnet in terms of corrosion resistance, wherein, in R—Fe—B based sintered permanent magnet containing a rare-earth element in an amount falling within a specific range and oxygen and carbon each in a specific amount or less, the nitrogen content is set in a specific range to thereby provide improved corrosion resistance, and, more specifically, the composition of the sintered permanent magnet is set such that it comprises, in terms of percent by weight, 27.0 to 31.0% of R, 0.5 to 2.0% of B, 0.02 to 0.15% of N, 0.25% or less of O, 0.15% or less of C, and Fe as the remainder.

In JP S62-133040 A (Patent Document 2), there are described a rare-earth permanent magnet material comprising, in terms of percent by weight, 25 to 40% of R (where R is Y or a rare-earth element), 0.7 to 7.5% of B, 0.05% or less of C, less than 0.3% of O, and M (where M is Fe and others) as the remainder, and, in Examples, a sintered body having an oxygen content of 0.15% and a carbon content of 0.006%, based on a new finding that C and O contents act as an important factor causing deterioration in magnetic properties, obtained through researches motivated by a suspicion against the conventional thought that, when attempting to produce, by a powder molding process, a permanent magnet comprising rare earth-iron-boron as a primary component, degradation of a raw material powder due to its high activity leads to a problem of severe deterioration in magnetic properties, and this phenomenon is caused by oxidation of a fine powder, i.e., by a suspicion that the phenomenon of deterioration in magnetic properties in a production process is not simply caused by oxidation of a fine powder, but greatly influenced by the presence of other minor components.

In JP 2006-219723 A (Patent Document 3), there is described an R—Fe—B based rare-earth permanent magnet comprised of a sintered body having a composition comprising 27.5 to 30.5 wt % of R (where R is one or more of rare-earth elements, wherein the term “rare-earth element” has a concept including Y), 0.5 to 4 wt % of B, 1.3 wt % or less of Co (except for 0), and 500 to 1500 ppm of C, with the remainder substantially consisting of Fe, based on a new finding that coercivity (HcJ) exhibits a peak value at a specific value of the C (carbon) content when each of the Co and R contents is set to fall within a specific range, although, in an an R—Fe—B based rare-earth permanent magnet, coercivity (HcJ) tends to gradually decrease along with an increase in C content, as long as each of the Co and R contents is set in a conventional range. Then, the Patent Document 3 mentions that, whereas, as a general tendency of a R—Fe—B based rare-earth permanent magnet as described in the Patent Document 3, a reduction in O content of the sintered body causes the microstructure thereof to become coarse, although setting the O content of the sintered body to 2000 ppm or less is desirable for high magnetic properties, the invention described in the Patent Document 3 makes it possible to enable the microstructure of the sintered body to be refined when the C content falls within a range in which high coercivity (HcJ) is obtained, thereby providing a fine crystal microstructure having an average crystal grain size of 3.4 μm or less.

As a production method completely different from the above conventional methods for producing a sintered body for forming a rare-earth magnet by a so-called powder compacting process, there is a rare-earth sintered magnet forming method comprising the steps of: mixing magnet material particles containing a rare-earth element with a binder to form a mixture; forming the mixture into a sheet shape to prepare a green sheet; applying a magnetic field to the green sheet to orient the particles of the green sheet according to the magnetic field; subjecting the resulting green sheet to calcining treatment to decompose and dissipate the binder; and then sintering the calcined green sheet at a sintering temperature, as disclosed in JP 2013-191612 A (Patent Document 4).

It is also disclosed that respective amounts of carbon and oxygen to be contained in a magnet can be reduced by using a given binder as the binder to be mixed with the magnet powder in the step of preparing a green sheet, and it is possible to reduce an amount of carbon to 2000 ppm or less, preferably 1000 ppm or less, and reduce an amount of oxygen to 5000 ppm or less, preferably 2000 ppm or less, in terms of an amount remaining in a magnet after sintering. Further, in the Patent Document 4, there is disclosed, before the step of mixing the magnet powder with a bonder, preparing the magnet power as a fine powder having an average particle size falling within a given range (e.g., ranging from 1.0 μm to 5.0 μm). However, there is no description about what level of particle size the magnet material particles have after sintering.

### CITATION LIST

### Patent Document

Patent Document 1: JP 3586577 B

Patent Document 2: JP S62-133040 A

Patent Document 3: JP 2006-219723 A

Patent Document 4: JP 2013-191612 A

Patent Document 5: U.S. Pat. No. 5,705,902 B

Patent Document 6: JP 2013-215021 A

### Non-Patent Document

Non-Patent Document 1: Journal of the Japan Institute of Metals and Materials, Vol. 76, No. 1 (2012), pp 12 to 16

Non-Patent Document 2: Journal of Magnetism and Magnetic Material, Vol. 97 (1991), pp 107 to 111

### SUMMARY OF INVENTION

### Technical Problem

As mentioned above, none of the Patent Documents and the Non-Patent Documents relating to production of a rare-earth permanent magnet discloses a sintered body for forming a rare-earth magnet whose carbon content is low enough not to adversely influence properties, particularly coercivity, of a magnet, and whose magnet material particles have an average particle size which is small enough to achieve excellent coercivity. In the conventional techniques, when attempting to reduce a size of pulverized particles of a magnet powder, the carbon content tends to increase, and, when attempting to reduce the carbon content, there is no other choice but to set the size of pulverized particles to a large value to some extent. It is conceivable to employ a method using a particular magnet material free of an organic component which would cause incorporation of carbon into a magnet material in the powder compacting process. In this case, however, there is concern that, due to an increase in aspect ratio of each magnet material particle, mechanical strength of a sintered body for forming a rare-earth magnet is deteriorated.

Further, when attempting to reduce a size of pulverized particles of a magnet powder so as to reduce an average particle size of magnet material particles, there is another problem of difficulty in controlling orientation of easy magnetization axes of the magnet material particles. Therefore, at present, it cannot be realized to obtain a rare-earth permanent magnet-forming sintered body having a unitary sintered structure, wherein it has an arbitrary shape, and easy magnetization axes of magnet material particles in each of an arbitrary plural number of regions of the sintered structure are oriented in a respective one of a plurality of different directions, despite a low carbon content or the use of a magnet powder whose pulverized particles have a relatively small particle size.

It is an object of the present invention to provide: a heretofore non-existing, novel sintered body for forming a rare-earth magnet having both of an extremely low carbon content and an extremely small average particle size of magnet material particles; a sintered body for forming a rare-earth magnet having an extremely low carbon content or an extremely small average particle size of magnet material particles, and having a zone in which easy magnetization axes are oriented in non-parallel relation to each other; and a magnet obtained by each of the rare-earth magnet-forming sintered bodies.

### Solution to Technical Problem

In order to achieve the above object, according to a first aspect of the present invention, there is provided a sintered body for forming a rare-earth magnet comprising a large number of magnet material particles sintered together, wherein each of the magnet material particles contains a rare-earth substance and has an easy magnetization axis. This sintered body for forming a rare-earth magnet has a carbon content of 500 ppm or less, and the magnet material particles have an average particle size of 2 μm or less.

Preferably, in the sintered body for forming a rare-earth magnet according the first aspect of the present invention, each of the magnet material particles has an aspect ratio of 2 or less.

Preferably, the sintered body for forming a rare-earth magnet according to the first aspect of the present invention has a unitary sintered structure, wherein the easy magnetization axes of the magnet material particles in each of an arbitrary plural number of regions of the sintered structure are oriented in a respective one of a plurality of different directions.

According to a second aspect of the present invention, there is provided a sintered body for forming a rare-earth magnet comprising a number of magnet material particles sintered together, wherein each of the magnet material particles contains a rare-earth substance and has an easy magnetization axis, and wherein: the sintered body for forming a rare-earth magnet has a unitary sintered structure, wherein the easy magnetization axes of the magnet material particles in each of an arbitrary plural number of regions of the sintered structure are oriented in a respective one of a plurality of different directions; and the sintered body for forming a rare-earth magnet has a carbon content of 500 ppm or less.

According to a third aspect of the present invention, there is provided a sintered body for forming a rare-earth magnet comprising a number of magnet material particles sintered together, wherein each of the magnet material particles contains a rare-earth substance and has an easy magnetization axis, and wherein: the sintered body for forming a rare-earth magnet has a unitary sintered structure, wherein the easy magnetization axes of the magnet material particles in each of an arbitrary plural number of regions of the sintered structure are oriented in a respective one of a plurality of different directions; and the magnet material particles have an average particle size of 2 μm or less.

Preferably, in the sintered body for forming a rare-earth magnet according the second or third aspect of the present invention, each of the magnet material particles has an aspect ratio of 2 or less.

According to a fourth aspect of the present invention, there is provided a rare-earth magnet formed by magnetizing any one of the above rare-earth magnet-forming sintered bodies.

### Effect of Invention

In the sintered body for forming a rare-earth magnet according to the present invention, the carbon content is 500 ppm or less, and the average particle size of the magnet material particles is 2 μm or less, so that a resulting magnetized magnet can have high coercivity. It also becomes possible to enable the easy magnetization axes of the magnet material particles in each of an arbitrary plural number of regions of the sintered structure to be oriented in a respective one of a plurality of different directions, despite the use of a relatively small size of pulverized particles of a magnet powder.

### BRIEF DESCRIPTION OF DRAWINGS

FIG. 1(a) is a cross-sectional overall view depicting a sintered body for forming a rare-earth magnet according to a first embodiment of the present invention.

FIG. 1(b) is a cross-sectional view depicting part of an end region of the sintered body for forming a rare-earth magnet according to the first embodiment.

FIG. 2 is a sectional view depicting a rotor segment to explain one example of a magnet-insertion slot provided in a rotor core of an electric motor and configured to allow a permanent magnet formed using a sintered body for forming a rare-earth magnet according to the present invention to be embedded therein.

FIG. 3 is an end view depicting the rotor segment to explain a state after the permanent magnet is embedded in the rotor core depicted in FIG. 2.

FIG. 4 is a cross-sectional view of an electric motor capable of using a permanent magnet according to the present invention.

FIG. 5 is a diagram depicting a magnetic flux density distribution in a rare-earth permanent magnet formed from the sintered body according to the first embodiment depicted in FIG. 1.

FIG. 6(a) is a schematic diagram depicting one step of forming a green sheet, in a production process of the permanent magnet-forming sintered body according to the first embodiment depicted in FIG. 1.

FIG. 6(b) is a schematic diagram depicting another step of forming a green sheet, in the production process of the permanent magnet-forming sintered body according to the first embodiment depicted in FIG. 1.

FIG. 6(c) is a schematic diagram depicting yet another step of forming a green sheet, in the production process of the permanent magnet-forming sintered body according to the first embodiment depicted in FIG. 1.

FIG. 6(d) is a schematic diagram depicting still another step of forming a green sheet, in the production process of the permanent magnet-forming sintered body according to the first embodiment depicted in FIG. 1.

FIG. 7(a) is a sectional view depicting a processing sheet piece magnetic field application during magnetic field application to explain orientation treatment for easy magnetization axes of magnet material particles in the first embodiment.

FIG. 7(b) is a sectional view depicting a sintering sheet piece as the processing sheet piece after being subjected to magnetic field application and then deformation treatment, to explain the orientation treatment for easy magnetization axes of magnet material particles in the first embodiment.

FIG. 7(c) is a sectional view depicting the processing sheet piece during a bending deformation processing step of deforming a first shaped body to a second shaped body, to explain the orientation treatment for easy magnetization axes of magnet material particles in the first embodiment.

FIG. 8 is a graph presenting a desirable temperature rising speed in calcining treatment.

FIG. 9(a) is a diagram depicting a first shaped body in a second embodiment of the present invention, similar to FIG. 7(a).

FIG. 9(b) is a diagram depicting a second shaped body in the second embodiment, similar to FIG. 7(b).

FIG. 10(a) is a diagram depicting a first shaped body in a third embodiment of the present invention, similar to FIG. 9(a).

FIG. 10(b) is a diagram depicting a second shaped body in the third embodiment, similar to FIG. 9(b).

FIG. 10(c) is a diagram depicting one modification of the second shaped body in the third embodiment, similar to FIG. 9(b).

FIG. 10(d) is a diagram depicting a first shaped body in a fourth embodiment of the present invention, similar to FIG. 9(a).

FIG. 10(e) is a diagram depicting a second shaped body in the fourth embodiment, similar to FIG. 9(b).

FIG. 10(f) is a diagram depicting one modification of the second shaped body in the fourth embodiment, similar to FIG. 9(b).

FIG. 11(a) is a side view depicting a first shaped body for producing a radially-oriented annular magnet, in a fifth embodiment of the present invention.

FIG. 11(b) is a perspective view depicting a second shaped body for producing a radially-oriented annular magnet, in the fifth embodiment.

FIG. 11(c) is a side view depicting a second shaped body for producing an axially-oriented annular magnet, in the fifth embodiment, wherein this second shaped body is formed into an annular shape by bending the first shaped body in a direction different from that for the second shaped body in FIG. 11(b).

FIG. 12 is a perspective view depicting one example of a Halbach array of magnets formed using the annular magnets produced according to the fifth embodiment in FIG. 11.

FIG. 13(a) is a schematic diagram depicting one production step in a sixth embodiment of the present invention.

FIG. 13(b) is a schematic diagram depicting another production step in the sixth embodiment.

FIG. 13(c) is a schematic diagram depicting yet another production step in the sixth embodiment.

FIG. 13(d) is a schematic diagram depicting still another production step in the sixth embodiment.

FIG. 13(e) is a schematic diagram depicting yet still another production step in the sixth embodiment.

FIG. 13(f) is a schematic diagram depicting another further production step in the sixth embodiment.

FIG. 14(a) is a schematic cross-sectional schematic view depicting one example of orientation of easy magnetization axes of magnet material particles in a rare-earth magnet, to explain an orientation angle and an orientation axis angle.

FIG. 14(b) is a schematic enlarged diagram depicting orientation angles and an orientation axis angle to explain a process of determining an “orientation angle” of an easy magnetization axis of each magnet material particle and an “orientation axis angle”.

FIG. 15 is a chart for explaining a process of determining an orientation-angle variation.

FIG. 16(a) is a perspective view depicting directions of axes of a rare-earth magnet to explain indication of a distribution of orientation angles based on EBSD analysis.

FIG. 16(b) depicts one example of pole figures obtained at a center and opposite ends of the rare-earth magnet by the EBSD analysis, to explain the indication of a distribution of orientation angles based on the EBSD analysis.

FIG. 16(c) depicts orientation axis angles in a section of the magnet taken along an A2-axis in FIG. 16(a), to explain the indication of a distribution of orientation angles based on the EBSD analysis.

FIG. 17(a) is a photographic representation for explaining a specific measurement method for a particle size of a magnet material particle.

FIG. 17(b) is another photographic representation for explaining a specific measurement method for a particle size of a magnet material particle.

### DESCRIPTION OF EMBODIMENTS

Before description of embodiments, definitions of some terms and measurement of an orientation angle will be described.

### [Orientation Angle]

The term “orientation angle” means an angle of the direction of an easy magnetization axis of a magnet material particle with respect to a predefined reference line.

### [Orientation Axis Angle]

The term “orientation axis angle” means the most frequently appearing orientation angle among orientation angles of magnet material particles contained in a predefined zone in a specific plane of a magnet. In the present invention, the zone for determining the orientation axis angle is a rectangular zone or a square zone having a side length of 35 μm, which contains at least 30 magnet material particles, e.g., 200 or 300 magnet material particles.

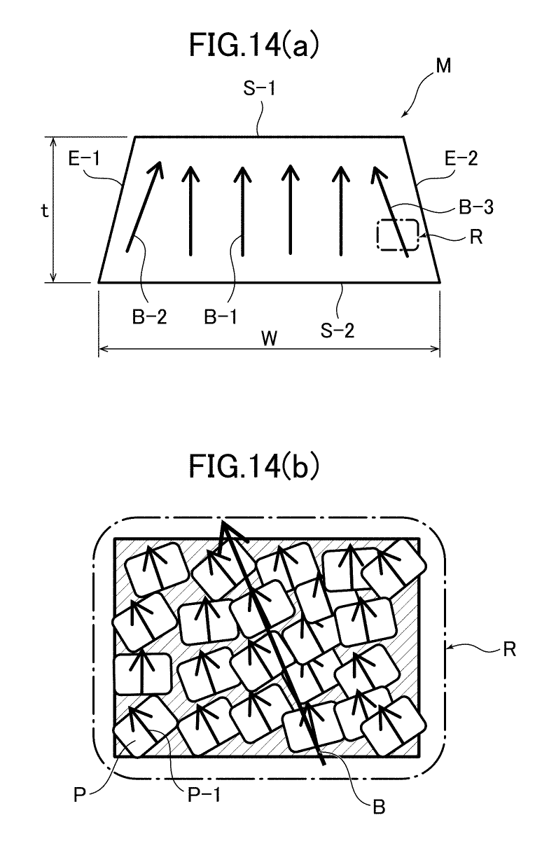

FIG. 14 illustrates an orientation angle and an orientation axis angle. FIG. 14(a) is a cross-sectional view depicting one example of orientation of easy magnetization axes of magnet material particles in a rare-earth magnet, wherein the rare-earth magnet M has a first surface S-1 and a second surface S-2 located spaced apart from the first surface S-1 by a thickness t, and has a width w, and wherein two end faces E-a and E-2 are formed, respectively, at width (W)-directionally opposite ends. In the illustrated embodiment, the first surface S-1 and the second surface S-2 are planar surfaces parallel to each other, and, in the illustrated cross-sectional view, the first surface S-1 and the second surface S-2 are indicated by two mutually parallel straight lines. The end face E-1 is formed as an inclined face whose upper side is inclined rightwardly with respect to the first surface S-1, and similarly the end face E-2 is formed as an inclined face whose upper side is inclined leftwardly with respect to the second surface S-2. An arrowed line B-1 generally indicates the direction of an orientation axis of easy magnetization axes of magnet material particles in a width-directional central region of the rare-earth magnet M. On the other hand, an arrowed line B-2 generally indicates the direction of an orientation axis of easy magnetization axes of magnet material particles in a region adjacent to the end face E-1. Similarly, an arrowed line B-3 generally indicates the direction of an orientation axis of easy magnetization axes of magnet material particles in a region adjacent to the end face E-2.

The “orientation axis angle” is an angle between the orientation axis indicated by the arrowed line B-1, B-2 or B-3 and one reference line. The reference line may be arbitrarily set. However, in the case where a cross-section of the first surface S-1 is indicated by a straight line, as in the example depicted in FIG. 14(a), the cross-sectional line of the first surface is conveniently used as the reference line. FIG. 14(b) is a schematic enlarged diagram for explaining a process of determining the “orientation angle” of the easy magnetization axis of each magnet material particle and the “orientation axis angle”. An arbitrary area of the rare-earth magnet M depicted in FIG. 14(a), e.g., a rectangular zone R depicted n FIG. 14(a), is enlargedly depicted n FIG. 14 (b). This rectangular zone R contains a large number of magnet material particles P, for example, 30 magnet material particles or more, specifically 200 to 300 magnet material particles. As the number of magnet material particles contained in the rectangular zone becomes larger, accuracy of angular measurement becomes higher. However, even when the number is about 30, the measurement can be performed with a sufficient accuracy. Each of the magnet material particles P has an easy magnetization axis P-1. Although the easy magnetization axis P-1 generally does not have any polarity (magnetic polarity), it becomes a vector having a polarity as a result of magnetization of the magnet material particle. In FIG. 14(b), considering a polarity to be imparted by magnetization, the easy magnetization axis is indicated by a line with an arrow indicative of direction. In the following description, the term “orientation direction of an easy magnetization axis” or any similar term will be used to express the direction of a polarity of the easy magnetization axis to be imparted by magnetization.

As depicted in FIG. 14(b), the easy magnetization axis P-1 of each magnet material particle P has an “orientation angle”, i.e., an angle between a direction along which the easy magnetization axis is oriented and a reference line. Then, among the “orientation angles” of the easy magnetization axes P-1 of the magnet material particles P in the rectangular zone R depicted in FIG. 14(b), the most frequently appearing angle is defined as an “orientation axis angle” B.

### [Orientation-Angle Variation]

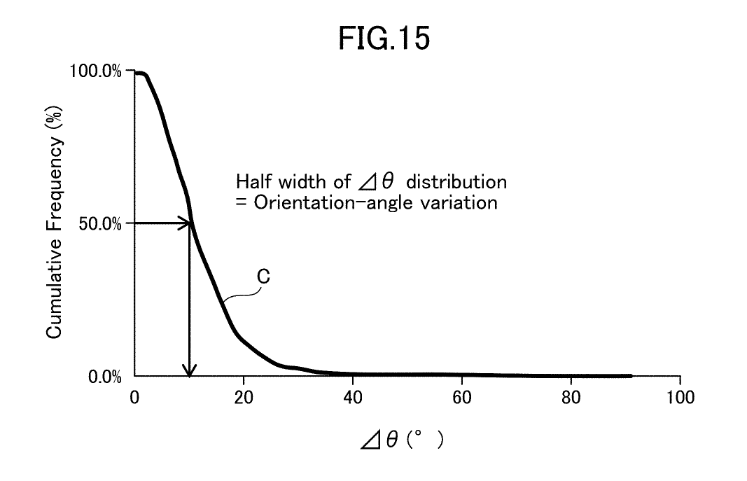

Regarding all magnet material particles existing in in an arbitrary rectangular zone, differences between an orientation axis angle in the rectangular zone, and respective ones of orientation angles of the magnet material particles are determined, and an angular value expressed by a half width in a distribution of the differences is defined as an orientation-angle variation. FIG. 15 is a chart for explaining a process of determining an orientation-angle variation. In FIG. 15, a distribution of the differences Δθ between the orientation axis angle and respective ones of the orientation angles of the easy magnetization axes of the magnet material particles is expressed as a curve C.

On an assumption that a position at which a cumulative frequency represented on the vertical axis is maximized is 100%, a value of the angular difference Δθ at a cumulative frequency of 50% corresponds to the half width.

### [Measurement of Orientation Angle]

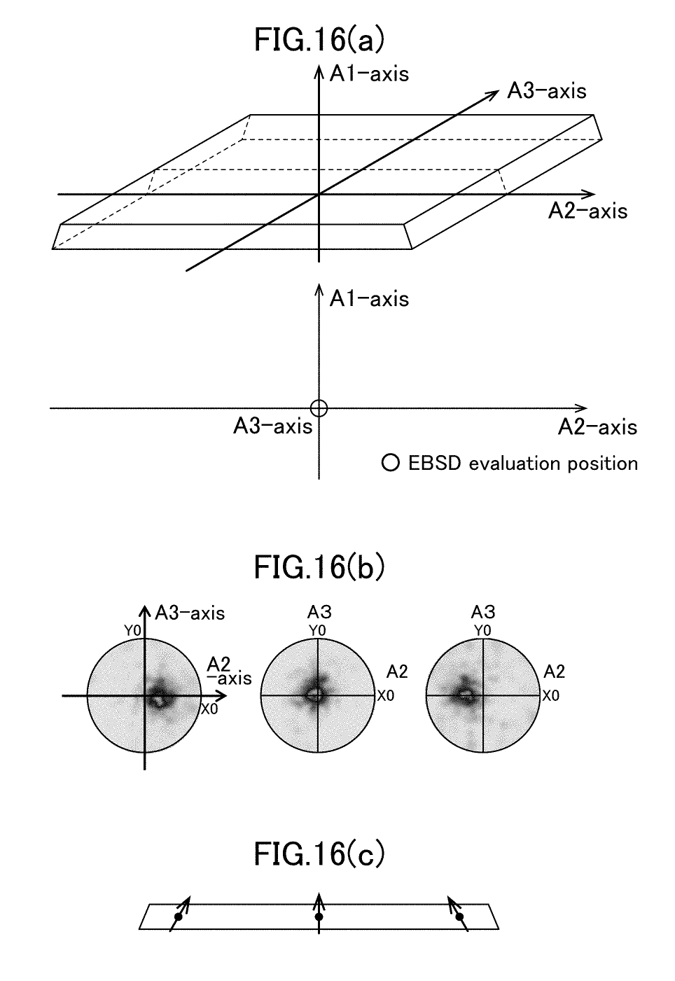

The orientation angle of the easy magnetization axis of each individual magnet material particle P can be determined by an “Electron Backscatter Diffraction Analysis Method” (EBSD Analysis method) based on scanning electron microscopic (SEM) images. Examples of a device for this analysis include JSM-70001F manufactured by JEOL Ltd., in Akishima City, Tokyo, Japan, which is a scanning electron microscope equipped with an EBSD detector (AZtecHKL EBSD NordlysNano Integrated) manufactured by Oxford Instruments plc., and SUPRA40VP manufactured by ZEISS, which is a scanning electron microscope equipped with an EBSD detector (Hikari High Speed EBSD Detector) manufactured by EDAX Inc. Further, as a business entity to which a customer can outsource an EBSD analysis, there are JFE Techno-Research Corporation in Nihonbashi, Chuo-ku, Tokyo, Japan, and Nitto Analytical Techno-Center Co., Ltd., in Ibaraki-city, Osaka, Japan. An EBSD analysis makes it possible to determine respective oriented angles of the easy magnetization axes of magnet material particles existing in a given zone, and the orientation axis angle in the given zone, and further obtain the orientation-angle variation based on values of the oriented angles and the orientation axis angle. FIG. 16 depicts one example of indication of the orientation of the easy magnetization axis according to EBSD analysis, wherein FIG. 16(a) is a perspective view depicting directions of axes of a rare-earth magnet, and FIG. 16(b) depicts one example of pole figures obtained at a center and opposite ends of the rare-earth magnet by the EBSD analysis. Further, FIG. 16(c) depicts orientation axis angles in a section of the magnet taken along the A2-axis. An orientation vector of the easy magnetization axis of each magnet material particle is divided into a first vector component in a plane including the A1-axis and the A2-axes, and a second vector component in a plane including the A1-axis and the A3-axes, and the orientation angle can be indicated by the first and second vector components. The A2-axis extends in a width direction, and the A1-axis extends in a thickness direction. The diagram in the middle of FIG. 16(b) indicates that, in a width-directional central region of the magnet, the easy magnetization axis is oriented in a direction approximately along the A1-axis. On the other hand, the diagram on the left side of FIG. 16(b) indicates that, in a widthwise directional left end region of the magnet, the orientation of the easy magnetization axis is inclined along a plain including A1-axis and the A2-axis (A1-A2 plane) obliquely upwardly and rightwardly. Similarly, the diagram on the right side of FIG. 16(b) indicates that, in a widthwise directional right end region of the magnet, the orientation of the easy magnetization axis is inclined along the A1-A2 plane obliquely upwardly and leftwardly. Such orientations are depicted as orientation vectors in FIG. 16(c).

### [Crystal Orientation Diagram]

A crystal orientation diagram is configured such that, with regard to each magnet material particle existing in an arbitrary zone, it presents an inclination angle of the easy magnetization axis of the magnet material particle, with respect to an axis perpendicular to an observation plane. This diagram can be created based on based on scanning electron microscopic (SEM) images.

With reference to the drawings, various embodiments of the present invention will now be described.

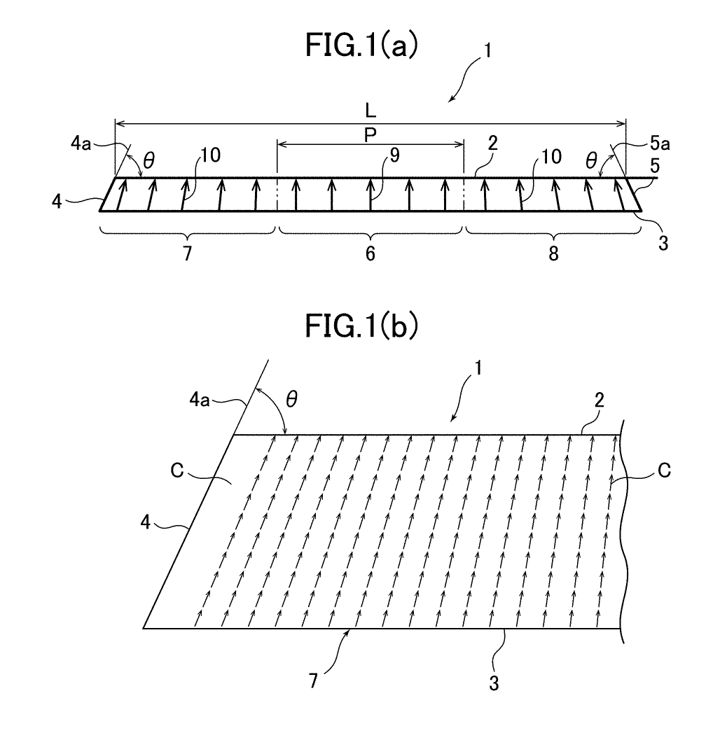

FIGS. 1 to 4 depict one example of a sintered body for forming a rare-earth magnet according to a first embodiment of the present invention and one example of an electric motor incorporating a permanent magnet formed from the sintered body. In this embodiment, a rare-earth permanent magnet 1 contains an Nd—Fe—B based magnet material as a magnet material. Typically, the Nd—Fe—B based magnet material contains 27 to 40 wt % of Nd, 0.8 to 2 wt % of B, and 60 to 70 wt % of Fe which is electrolytic iron. With a view to improving magnetic properties, this magnet material may contain a small amount of one or more other elements, such as Dy, Tb, Co, Cu, Al, Si, Ga, Nb, V, Pr, Mo, Zr, Ta, Ti, W, Ag, Bi, Zn, and/or Mg.

The sintered body for forming a rare-earth magnet according to the present invention has a carbon content of 500 ppm or less, on the basis of the weight of the entire sintered body for forming a rare-earth magnet. From a viewpoint of increasing coercivity, the carbon content is preferably set to 300 ppm or less. Further, it is desirable that this sintered body for forming a rare-earth magnet has an oxygen content of 4500 ppm or less, and a nitrogen content of 350 ppm or less, and a hydrogen content of 1500 ppm or more. These carbon, nitrogen, oxygen and hydrogen contents can be checked by analyzing the sintered body for forming a rare-earth magnet using commercially-available analyzers such as a carbon content analyzer, an oxygen-nitrogen analyzer and a hydrogen analyzer. Carbon, oxygen, nitrogen, and hydrogen contained in the sintered body for forming a rare-earth magnet are entirely incorporated during a production process of the sintered body for forming a rare-earth magnet.

Referring to FIG. 1(a), the magnet-forming sintered body 1 according to this embodiment is obtained by integrally sintering fine particles of the above magnet material while forming the magnet material particles into a given shape, wherein the sintered body has: an upper side 2 and a lower side 3 parallel to each other; and respective end faces 4, 5 at left and right opposite ends thereof, and wherein each of the end faces 4, 5 is formed as an inclined face inclined with respect to the upper side 2 and the lower side 3. The upper side 2 is a side corresponding to a cross-section of a first surface of the invention, and the lower side 3 is a side corresponding to a cross-section of a second surface of the invention. In a preferred embodiment, the inclination angle θ is in the range of 45° to 80°, preferably in the range of 55° to 80°. As a result, the magnet-forming sintered body 1 is formed such that a cross-section which is perpendicular to a length direction thereof has a trapezoidal shape in which the upper side 2 is shorter than the lower side 3.

In the width direction along the upper side 2 and the lower side 3, the magnet-forming sintered body 1 has a plurality of regions sectionalized into a central region 6 having a given width dimension, and two end regions 7, 8 each on the side of a respective one of the left and right opposite ends thereof. In the central region 6, the easy magnetization axes of the magnet material particles contained in the central region 6 have a parallel orientation in which they are oriented parallel to a thickness direction substantially perpendicular to the upper side 2 and the lower side 3. On the other hand, in each of the end regions 7, 8, the easy magnetization axes of the magnet material particles contained in the end region 7 or 8 are oriented in directions each extending upwardly while inclining toward the central region 6 with respect to the thickness direction, wherein an angle of the inclination is set such that: at a position adjacent to each of the end faces 4, 5, it conforms to the inclination angle θ of each of the end faces 4, 5; at a position adjacent to the central region 6, it is approximately perpendicular to the upper side 2; and it gradually increases in a direction extending from a position adjacent to each of the end faces 4, 5 toward the central region 6. As regards the orientations of the easy magnetization axes, the parallel orientation in the central region 6 and an oblique or inclined orientation in each of the end regions 7, 8 are indicated, respectively, by the arrowed lines 9 and the arrowed lines 10. Expressing the inclined orientation in each of the end regions 7, 8 differently, the easy magnetization axes of the magnet material particles contained in the end region are oriented so as to be converged in a region falling within a given range corresponding to a width dimension of the end region 7 or 8 extending from a corner at which the upper side 2 and the end face 4 or 5 intersect each other, to the central region. As a result of this inclined orientation, in each of the end regions 7, 8, the density of the magnet material particles whose easy magnetization axes are directed toward the upper side 2 becomes greater than that in the central region 6. In a preferred embodiment of the present invention, respective dimensions of the central region 6 and each of the end regions 7, 8 is set such that a ratio of a width dimension of a part of the upper side 2 corresponding to the central region 6, i.e., a parallel length P, to a width dimension L of the upper side 2, i.e., a parallel ratio P/L, falls within the range of 0.05 to 0.8, preferably 0.2 to 0.5. In this embodiment, as compared to the central region 6, orientations of the easy magnetization axes of the magnet material particles at positions close to the end face of each of the end regions 7, 8 are different by 20° or more in terms of the orientation axis angle. In this specification, such orientation is referred to as a “non-parallel orientation”.

FIG. 1(b) exaggeratingly depicts the end region 7 which is presented as a representative example for explaining the orientations of the easy magnetization axes of the magnet material in the end regions 7, 8. Referring to FIG. 1(b), in an area adjacent to the end face 4, the easy magnetization axis of each magnet material particle is oriented approximately along the end face 4, i.e., to be inclined at an angle approximately conforming to the inclination angle θ of the end face 4. The inclination angle gradually increases in a direction extending from the end face toward the central region. That is, the orientations of the easy magnetization axes C of the magnet material particles are converged in a direction from the lower side 3 toward the upper side 2, so that the density of the magnet material particles whose easy magnetization axes C are directed toward the upper side 2 is increased, as compared to the region having the parallel orientation.

In the sintered body for forming a rare-earth magnet according to the present invention, the magnet material particles have an average particle size of 2 μm or less. From the viewpoint of increasing coercivity, the average particle size of the magnet material particles is preferably 1.5 μm or less. As used in this specification, the term “average particle size of the magnet material particles” means an average particle size of sintered magnet material particles in an obtained sintered body, which is different from an average particle size of pulverized particles of a magnet powder obtained through pulverization in a production process of the sintered body. The average particle size of the magnet material particles can be measured using a commercially-available SEM equipped with an EBSD detector.

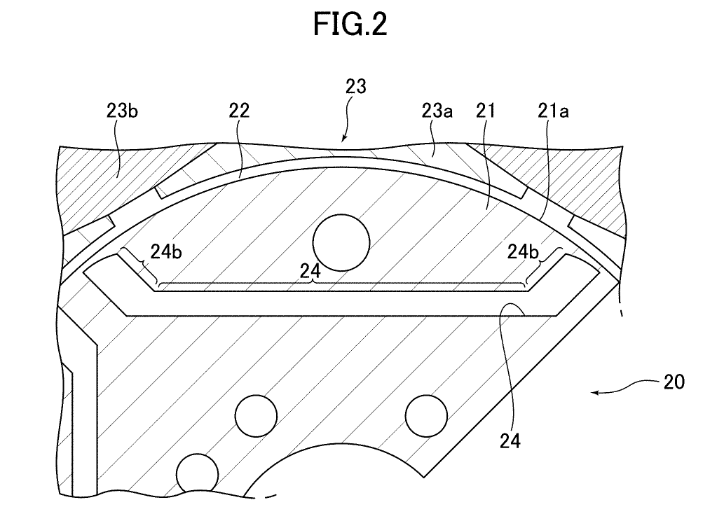

FIG. 2 is a sectional view enlargedly depicting a rotor core segment of an electric motor 20 suited to embeddedly using a rare-earth magnet formed by magnetizing the magnet-forming sintered body 1 having the easy magnetization axes oriented in the above manner. A rotor core 21 is rotatably disposed inside a stator 23 such that an outer peripheral surface 21a of the rotor core 21 is opposed to the stator 23 through an air gap 22. The stator 23 comprises a plurality of teeth 23a arranged at intervals in a circumferential direction thereof. A field coil 23b is wound around each of the teeth 23a. The air gap 22 is formed between end faces of the teeth 23a and the outer peripheral surface 21a of the rotor core 21. The rotor core 21 is formed with a magnet-insertion slot 24. This slot 24 has a linear central section 24a, and a pair of inclined sections 24b each extending obliquely from a respective one of opposite ends of the central section 24a toward the outer peripheral surface 21a of the rotor core 21. As seen from FIG. 2, the inclined section 24b is formed such that a distal end thereof is located at a position adjacent to the outer peripheral surface 21a of the rotor core 21.

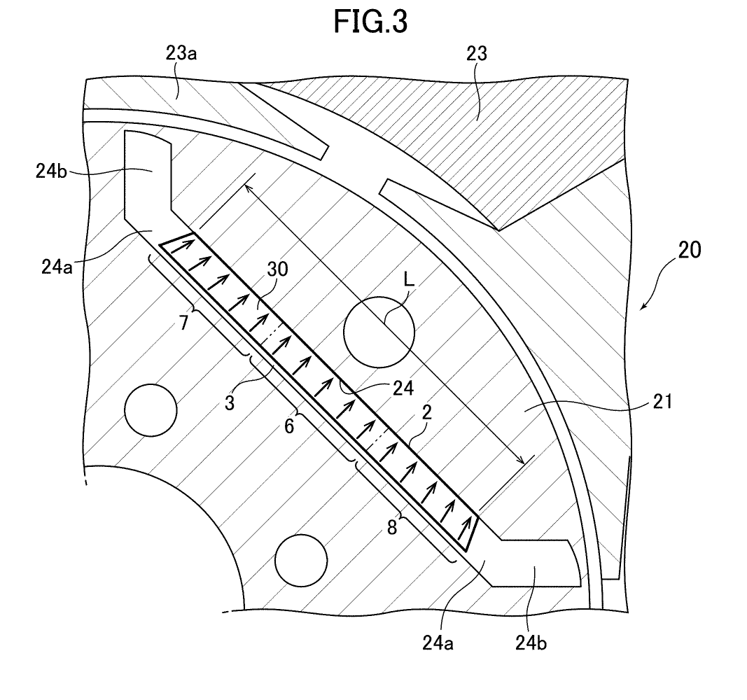

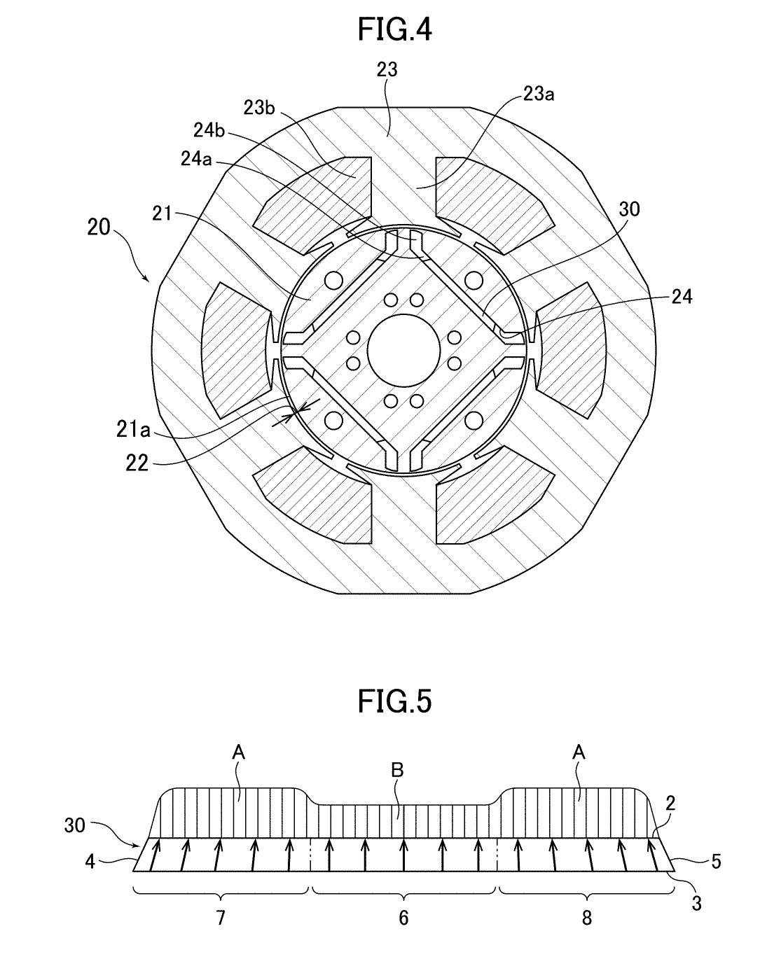

FIG. 3 depicts a state after a rare-earth magnet 30 formed by magnetizing the magnet-forming sintered body 1 having the easy magnetization axes oriented in the above manner is inserted into the magnet-insertion slot 24 of the rotor core 21 depicted in FIG. 2. As depicted in FIG. 3, the rare-earth permanent magnet 30 is inserted into the linear central section 24a of the magnet-insertion slot 24 formed in the rotor core 21 in such a manner that the upper side 2 thereof faces outwardly, i.e., toward the stator 23. On an outward side with respect to each of opposite ends of the inserted permanent magnet 30, part of the linear central section 24a and the inclined section 24b of the slot 24 are left as a void space. FIG. 4 is a cross-sectional view depicting an entirety of the electric motor 20 formed by inserting the permanent magnet into the slot 24 of the rotor core 21 in the above manner.

FIG. 5 depicts a magnetic flux density distribution in the rare-earth permanent magnet 30 formed in the above embodiment. As depicted in FIG. 5, a magnetic flux density A in each of the end regions 7, 8 of the magnet 30 is greater than a magnetic flux density B in the central region 6 of the magnet 30. Thus, during operation of the electric motor 20 with this magnet 30 embedded in the rotor core 21, even when a magnetic flux is applied from the stator 23 to the ends of the magnet 30, demagnetization of the ends of the magnet 30 is suppressed, and a sufficient magnetic flux remains in the ends of the magnet 30 after the demagnetization. This prevents reduction in power output of the motor 20.

### [Production Method for Rare-Earth Permanent Magnet-Forming Sintered Body]

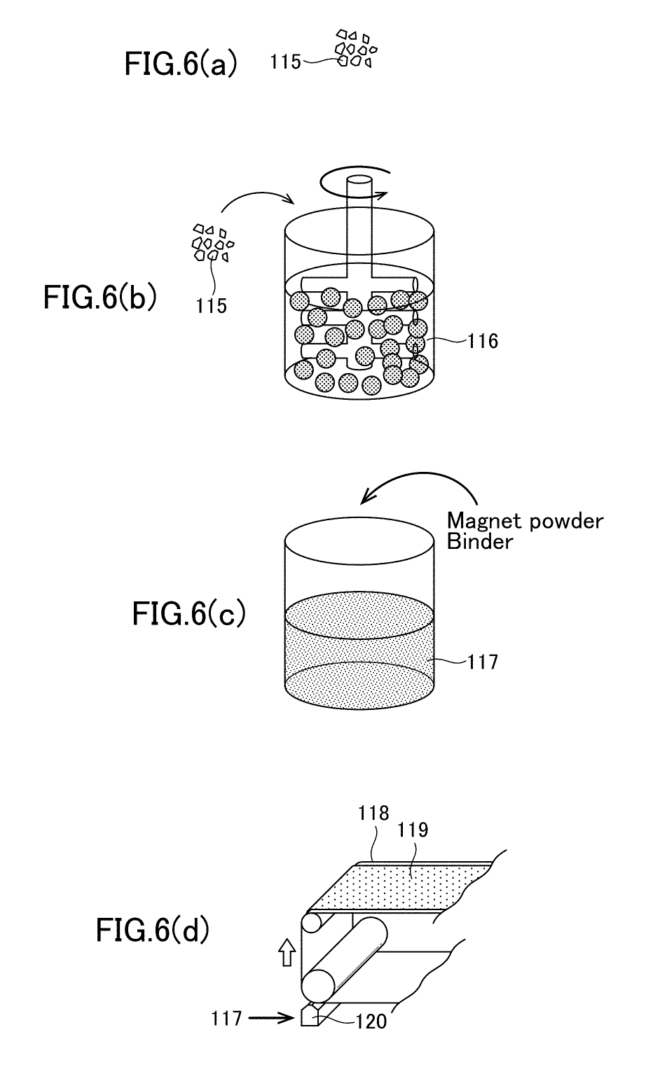

Next, with reference to FIG. 6, a production method for the sintered body for forming a rare-earth magnet 1 according to the first embodiment depicted in FIG. 1 will be described. FIG. 6 is a schematic diagram depicting a production process of the permanent magnet-forming sintered body 1 according to the first embodiment.

First of all, an ingot of a magnet material comprised of a Nd—Fe—B based alloy having a given mixing ratio is produced by a casting process. Typically, the Nd—Fe—B based alloy usable for a neodymium magnet has a composition comprising 30 wt % of Nd, 67 wt % of Fe which is preferably electrolytic iron, and 1.0 wt % of B. Subsequently, this ingot is coarsely pulverized to a size of about 200 μm, using heretofore-known means such as a stamp mill or a crusher. Alternatively, the ingot may be melted and subjected to a strip casting process to produce flakes, and then the flakes may be coarsely powdered by a hydrogen cracking process. In this way, coarsely-pulverized magnet material particles 115 are obtained (see FIG. 6(a)).

Particularly, in the present invention, it is desirable to perform the coarse pulverization using high-pressure hydrogen cracking to thereby reduce a final particle size of pulverized particles. Further, in some cases, the particle size of pulverized particles can be reduced by performing the coarse pulverization under cooling using liquefied Ar or the like. Thus, it is desirable to perform the coarse pulverization by employing such a cooling technique.

Subsequently, the coarsely-pulverized magnet material particles 115 are finely pulverized by a wet process using a bead mill 116, a dry process using a jet mill, or the like. For example, in the fine pulverization based on the wet process using the bead mill 116, the coarsely-pulverized magnet particles 115 are finely pulverized, in a solvent, to a particle size falling within a given range, e.g., 0.1 μm to 5.0 μm, to thereby disperse the resulting magnet material particles in the solvent (see FIG. 6(b)). For example, it is desirable to perform the fine pulverization under the condition that a bead diameter and a pulverization time are set, respectively, to 2 mm φ or less and 2 hours or more, and an amount of the coarse powder is set to 10 weight parts or less with respect to 100 weight parts of the beads. Subsequently, the magnet particles contained in the solvent after the wet pulverization are dried by drying mean such as vacuum drying, and the dried magnet particles are extracted (not depicted). A type of solvent to be used in the pulverization is not particularly limited. For example, it is possible to use an organic solvent including: alcohols such as isopropyl alcohol, ethanol and methanol; esters such as ethyl acetate; lower hydrocarbons such as pentane and hexane; aromatics such as benzene, toluene and xylene; and ketones; and mixtures thereof, and an inorganic solvent such as liquefied nitrogen, liquefied helium or liquefied argon. In any case, it is preferable to use a solvent containing no oxygen atom therein.

On the other hand, in the fine pulverization based on a dry process using a jet mill, the coarsely-pulverized magnet material particles 115 are finely pulverized by the jet mill, in (a) an atmosphere consisting inert gas such as nitrogen gas, Ar gas or He gas, wherein an oxygen content of the inert gas is 0.5% or less, preferably substantially 0%, or (b) an atmosphere consisting inert gas such as nitrogen gas, Ar gas or He gas, wherein an oxygen content of the inert gas is in the range of 0.0001 to 0.5%, and formed as fine particles having an average particle size falling within a given range, such as 0.7 μm to 5.0 μm. As used herein, the term “the concentration of oxygen is substantially 0%” does not limitedly mean that the concentration of oxygen is absolutely 0%, but means that oxygen may be contained in an amount to an extent that it very slightly forms an oxide layer on surfaces of the fine particles. The jet mill pulverization using He gas is preferable from a standpoint of its capability of generally obtaining a smaller particle size as compared with the jet mill pulverization under a nitrogen gas atmosphere. In any of the pulverization methods, the fine pulverization can be promoted by adding an appropriate pulverization aid.

Subsequently, the magnet material particles finely pulverized by the bead mill 116 or the like are formed into a desired shape. For shaping of the magnet material particles, a mixture obtained by mixing the magnet material particles 115 finely pulverized in the above manner and a binder together, i.e., a composite material, is preliminarily prepared. Preferably, a resin to be used as the binder is a polymer containing no oxygen atom in its structure and having a depolymerization property. Further, it is preferable to use a thermoplastic resin so as to enable a residue of the composite material of the magnet particles and the binder, occurring when the composite material is formed into a desired shape, as described later, to be reused, and enable magnetic field orientation to be performed under the condition that the composite material is softened by heating. More specifically, a polymer is suitably used which comprises one or more polymers or copolymers formed from a monomer represented by the following general formula (1).

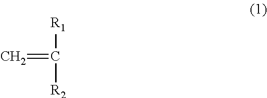

(where each of R1 and R2 denotes one of a hydrogen atom, a lower alkyl group, a phenyl group and a vinyl group.)

Examples of a polymer meeting the above conditions include: polyisobutylene (PIB) as a polymer of isobutylene; polyisoprene (isoprene rubber (IR)) as a polymer of isoprene; polybutadiene (butadiene rubber (BR)) as a polymer of 1,3-butadiene; polystyrene as a polymer of styrene; a styrene-isoprene block copolymer (SIS) as a copolymer of styrene and isoprene; butyl rubber (IIR) as a copolymer of isobutylene and isoprene; a styrene-butadiene block copolymer (SBS) as a copolymer of styrene and butadiene; a styrene-ethylene-butadiene-styrene copolymer (SEBS) as a copolymer of styrene, ethylene and butadiene; a styrene-ethylene-propylene-styrene copolymer (SEPS) as a copolymer of styrene, ethylene and propylene; an ethylene-propylene copolymer (EPM) as a copolymer of ethylene and propylene; EPDM obtained by copolymerizing diene monomers together with ethylene and propylene; polyethylene as a polymer of ethylene; polypropylene as a polymer of propylene; a 2-methyl-1-pentene polymerized resin as a polymer of 2-methyl-1-pentene; and a 2-methyl-1-butene polymerized resin as a polymer of 2-methyl-1-butene. A resin to be used as the binder may have a composition comprising a small amount of polymer or copolymer of monomers containing an oxygen atom and/or a nitrogen atom (e.g., poly(butyl methacrylate) or poly(methyl methacrylate)). Further, a monomer which does not meet the general formula (1) may be partially copolymerized. Even in this case, it is possible to achieve the object of the present invention.

As a resin to be used as the binder, it is desirable, from a viewpoint of adequately performing magnetic field orientation, to use a thermoplastic resin capable of being softened at a temperature of 250° C. or less (i.e., having a softening temperature of 250° C. or less), more specifically a thermoplastic resin having a glass-transition temperature or flow starting temperature of 250° C. or less.

In order to disperse the magnet material particles over the thermoplastic resin, it is desirable to add an orientation lubricant in an appropriate amount. As the orientation lubricant, it is desirable to add at least one selected from the group consisting of alcohol, carboxylic acid, ketone, ether, ester, amine, imine, imide, amide, cyanogen, phosphorous functional group, sulfonic acid, a compound having an unsaturated bond such as a double bond or a triple bond, and a liquid, saturated hydrocarbon compound. Two or more of them may be used in the form of a mixture. Further, in advance of operation described below of applying a magnetic field to the mixture of the magnet material particles and the binder, i.e., the composite material, to thereby magnetically orient the magnet material particles, the mixture is heated to allow such magnetic field orientation treatment to be performed under the condition that the binder component is softened.

By using a binder satisfying the above conditions to serve as the binder to be mixed with the magnet material particles, it is possible to reduce respective amounts of carbon and oxygen remaining in a rare-earth permanent magnet-forming sintered body after sintering. Specifically, an amount of carbon remaining in the magnet-forming sintered body after sintering can be reduced to 2000 ppm or less, more preferably 1000 ppm or less. In the present invention, the carbon content of the sintered body for forming a rare-earth magnet is set to 500 ppm or less, preferably 300 ppm or less. Further, an amount of oxygen remaining in the magnet-forming sintered body after sintering can be reduced to 5000 ppm or less, more preferably 2000 ppm or less.

An addition amount of the binder is set to a value capable of, when shaping a slurry-form or heated and melted composite material, adequately filling gaps among the magnet material particles so as to provide improved thickness accuracy to a shaped body obtained as a result of the shaping. For example, a ratio of the binder to a total amount of the magnet material particles and the binder is set in the range of 1 wt % to 40 wt %, more preferably in the range of 2 wt % to 30 wt %, even more preferably in the range of 3 wt % to 20 wt %.

In the following embodiment, the composite material is formed into a shape other than a desired product shape once, and a parallel magnetic field is applied to the resulting shaped body to subject the magnet material particles in the shaped body to orientation under the magnetic field, then the resulting shaped body is formed into the desired product shape, and then subjected to sintering to obtain a sintered magnet having the desired product shape such as a trapezoidal shape as depicted in FIG. 1. Particularly, in the following embodiment, the mixture consisting of the magnet material particles and the binder, i.e., the composite material 117, is formed into a sheet-like green (unprocessed or untreated) shaped body (hereinafter referred to as “green sheet”) once, and then further formed into a shape for the orientation treatment. In the case where the composite material is formed, particularly, into a sheet shape, it is possible to employ a forming process such as: a hot-melt coating process which comprises heating the composite material 117, i.e., the mixture of the magnet material particles and the binder, and then coating the resulting melt onto a substrate to thereby form the melt into a sheet shape; or a slurry coating process which comprises coating a slurry containing the magnet material particles, the binder and an organic solvent, on a substrate, to thereby form the slurry into a sheet shape.

In the case where it is necessary to obtain the parallel orientation of easy magnetization axes, a parallel magnetic field may be applied to a shaped body formed in a desired product shape, to subject the magnet material particles in the shaped body to orientation under the magnetic field, and then the resulting shaped body may be subjected to sintering.

Although the following description will be made about formation of the green sheet using, particularly, the hot-melt coating process, the present invention is not limited to such a specific forming process. For example, the composite material 117 may formed into a desired shape, such that it is put in a shaping die, and applied with a pressure of 0.1 to 100 MPa while being heated from room temperature to 300° C. More specifically, this shaping process may comprise: heating the composite material 117 to a softening temperature; and injecting and filling the softened composite material 117 into a die while applying an injection pressure thereto.

A binder is mixed with the magnet material particles finely pulverized using the bead mill 116 or the like, to prepare a clayey mixture comprising the magnet material particles and the binder, i.e., a composite material 117, as previously mentioned. In this process, it is possible to use, as the binder, a mixture of a resin and an orientation lubricant as mentioned above. As one example of the binder, it is preferable to use a thermoplastic resin comprising a polymer containing no oxygen atom in its structure and having a depolymerization property. Further, as the orientation lubricant, it is preferable to add at least one selected from the group consisting of alcohol, carboxylic acid, ketone, ether, ester, amine, imine, imide, amide, cyanogen, phosphorous functional group, sulfonic acid, and a compound having an unsaturated bond such as a double bond or a triple bond. With regard to an addition amount of the binder, in the composite material 117 after addition of the binder, a ratio of the binder to a total amount of the magnet material particles and the binder is set in the range of 1 wt % to 40 wt %, more preferably in the range of 2 wt % to 30 wt %, even more preferably in the range of 3 wt % to 20 wt %, as mentioned above.

Further, an addition amount of the orientation lubricant is preferably determined depending on a particle size of the magnet material particles, wherein it is recommended to gradually increase the addition amount as the particle size of the magnet material particles becomes smaller. Specifically, the addition amount may be set in the range of 0.1 weight parts to 10 weight parts, preferably in the range of 0.3 weight parts to 8 weight parts, with respect to 100 weight parts of the magnet material particles. If the addition amount is excessively small, a dispersion effect becomes poor, possibly leading to deterioration in orientation property. On the other hand, if the addition amount is excessively large, the orientation lubricant is likely to contaminate the magnet material particles. The orientation lubricant added to the magnet material particles adheres onto surfaces of the magnet material particles, and acts to facilitate dispersion of the magnet material particles to provide the clayey mixture, and to assist turning of the magnet material particles in the magnetic field orientation treatment described below. As a result, it becomes possible to facilitate orientation during application of a magnetic field so as to uniform respective directions of easy magnetization axes of the magnet particles, into approximately the same direction, i.e., so as to increase a degree of orientation. Particularly, when the binder is mixed with the magnet material particles, the binder is present around the surfaces of the magnet material particles, so that a frictional force against the magnet material particles during the magnetic field orientation treatment is increased, thereby possibly leading to deterioration in orientation property of the magnet material particles. Thus, the effect arising from addition of the orientation lubricant becomes more important.

Preferably, the mixing of the magnet material particles and the binder is performed in an atmosphere consisting of inert gas such as nitrogen gas, Ar gas or He gas. As one example, the mixing of the magnet material particles and the binder is performed by inputting the magnet material particles and the binder into a stirring machine and stirring them using the stirring machine. In this case, with a view to enhancing kneading performance, heating-stirring (stirring under heating), reduced pressure-stirring (stirring under reduced pressure) or reduced pressure-heating-stirring (stirring under reduced pressure and heating) may be performed. It is also desirable to perform the mixing of the magnet material particles and the binder, in an atmosphere consisting of inert gas such as nitrogen gas, Ar gas or He gas. Particularly, in the case where the magnet material particles are pulverized by a wet process, the composite material 117 may be obtained by adding the binder to a solvent used for pulverization, without extracting the magnet material particles from the solvent, and, after kneading the resulting mixture, volatilizing the solvent.

Subsequently, the composite material 117 is formed into a sheet shape to prepare the aforementioned green sheet. Specifically, in the case of employing the hot-melt coating process, the composite material 117 is heated and melted to have flowability, and then coated on a support substrate 118. Subsequently, the composite material 117 is solidified according to heat dissipation to form a long strip-shaped green sheet 119 on the support substrate 118 (see FIG. 6(d). In this case, although a temperature to be set during heating and melting of the composite material 117 varies depending on a type and an amount of a binder used, it is typically set in the range of 50 to 300° C. In this case, it is to be understood that the temperature needs to be set to a value greater than the flow starting temperature of the binder used. On the other hand, in the case of employing the slurry coating process, a slurry obtained by dispersing the magnet material particles, the binder and optionally an additive for facilitating the orientation, over a large volume of solvent is coated on the support substrate 118. Subsequently, the slurry is subjected to drying to volatilize the solvent therefrom to thereby form a long strip-shaped green sheet 119 on the support substrate 118.

As a coating system for the melted composite material 117, it is preferable to use a system having excellent layer thickness controllability, such as a slot-die system or a calender roll system. Particularly, in order to realize high thickness accuracy, it is desirable to use a die system or a comma coating system which is a system having particularly excellent layer thickness controllability, i.e., a system capable of coating a layer having a highly-accurate thickness, on a surface of a substrate. For example, in the slot-die system, the composite material 117 after being heated to have flowability is pressure-fed from a gear pump into a die, and discharged from the die to perform coating. On the other hand, in the calender roll system, the composite material 117 is fed into a nip gap between two heated rolls, in a controlled amount, and the rolls are rotated to coat the composite material 117 melted by heat of the rolls, onto the support substrate 118. As one example of the support substrate 118, it is preferable to use a silicone-treated polyester film. Further, it is preferable to use a defoaming agent or perform a vacuum heating defoaming process to sufficiently defoam a layer of the coated and developed composite material 117 so as to prevent gas bubbles from remaining in the layer. Alternatively, the melted composite material 117 may be extruded onto the support substrate 118 while being formed into a sheet shape, by an extrusion forming or injection forming, instead of being coated on the support substrate 118, to thereby form the green sheet 119 on the support substrate 118.

In the embodiment depicted in FIG. 6, coating of the composite material 117 is performed using a slot-die 120. In a step of forming the green sheet 119 using this slot-die system, it is desirable to actually measure a sheet thickness of the coated green sheet 119, and adjust a nip gap between the slot-die 120 and the support substrate 118, by feedback control based on the actually-measured value. In this case, it is desirable to reduce a variation in an amount of the flowable composite material 117 to be fed to the slot-die 120, as small as possible, e.g., to ±0.1% or less, and further reduce a variation in coating speed as small as possible, e.g., to ±0.1% or less. This control makes it possible to improve the thickness accuracy of the green sheet 119. As one example, with respect to a design value of 1 mm, the thickness accuracy of the actually formed green sheet 119 may be set to fall within ±10%, preferably within ±3%, more preferably within ±1%. In the calender roll system, a film thickness of the composite material 117 to be transferred to the support substrate 118 can be controlled by feedback-controlling calendering conditions based on an actually-measured value in the same manner as that described above.

Preferably, the thickness of the green sheet 119 is set in the range of 0.05 mm to 20 mm. If the thickness is reduced to less than 0.05 mm, it becomes necessary to laminate a plurality of layers so as to achieve a required magnet thickness, resulting in deteriorated productivity.

Subsequently, the green sheet 119 formed on the support substrate 118 by the hot-melt coating process is cut into a processing sheet piece 123 having a size corresponding to a desired magnet size. The processing sheet piece 123 corresponds to a first shaped body of the invention whose shape is different from that of a desired magnet. Specifically, the processing sheet piece 123 corresponding to the first shaped body is formed into a shape which enables a magnet having a desired shape to have a desired non-parallel orientation of easy magnetization axes, when a parallel magnetic field is applied the processing sheet piece 123 to cause the easy magnetization axes of the magnet material particles contained in the processing sheet piece 123 to be oriented in parallel relation, and then the resulting processing sheet piece is deformed so as to form the magnet having the desired shape.

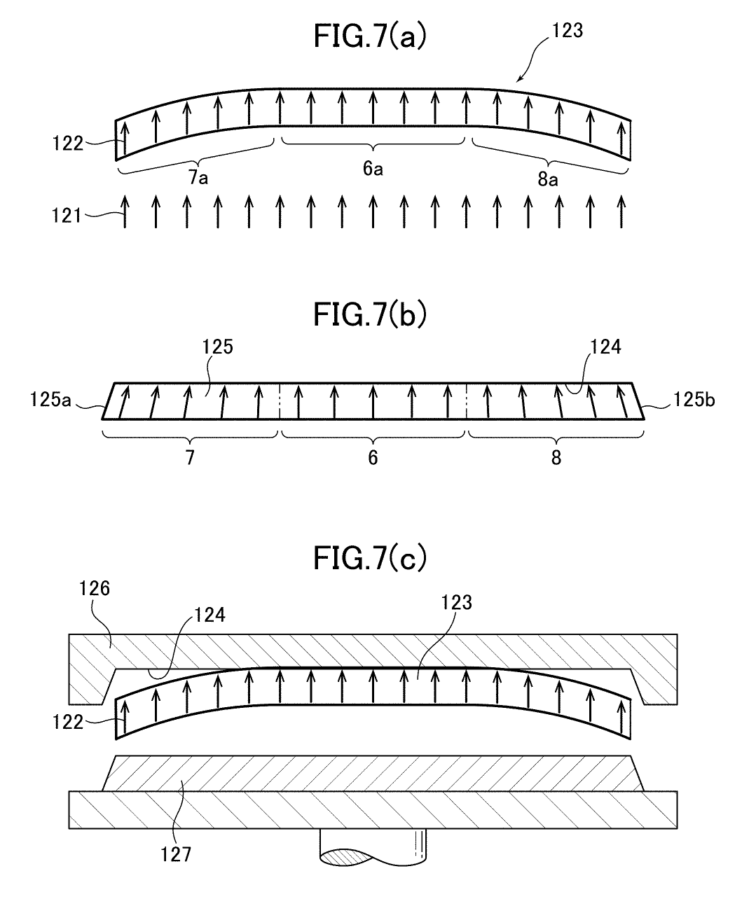

In the first embodiment, as depicted in FIG. 7(a), the processing sheet piece 123 as the first shaped body has a cross-sectional shape comprising: a linear region 6a having a width dimension corresponding to the central region 6 in the cross-sectionally trapezoidal rare-earth permanent magnet-forming sintered body 1 as a final product, and two arc-shaped regions 7a, 8a continuous, respectively, with opposite ends of the linear region 6a. This processing sheet piece 123 has a length dimension in a direction perpendicular to the plane of the drawing sheet, and dimensions of this cross-section and the length dimension are set while taking into account a dimensional shrinkage during a sintering step described below, such that given magnet dimensions can be obtained after the sintering step.

A parallel magnetic field 121 is applied to the processing sheet piece 123 depicted in FIG. 7(a), in a direction perpendicular to surfaces of the linear region 6a. Through this magnetic field application, the easy magnetization axes of the magnet material particles contained in the processing sheet piece 123 are oriented in the direction of the magnetic field, i.e., in a direction parallel to a thickness direction of the processing sheet piece 123, as depicted by the arrowed lines 122 in FIG. 7(a). Specifically, the processing sheet piece 123 is placed in a magnetic field application die (not depicted) having a cavity with a shape corresponding to that of the processing sheet piece 123, and heated to soften the binder contained in the processing sheet piece 123. This enables the magnet material particles to be turned within the binder, i.e., enables the easy magnetization axes of the magnet material particles to be oriented in directions along the parallel magnetic field 121.

In this process, although a temperature and a time to be set during heating of the processing sheet piece 123 vary depending on a type and an amount of a binder used, they may be set, respectively, to 40 to 250° C. and 1 to 60 minutes, for example. In either case, for softening the binder contained in the processing sheet piece 123, the heating temperature needs to be set to a value equal to or greater than a glass-transition temperature or flow starting temperature of the binder used. Examples of a means to heat the processing sheet piece 123 include a heating system using a hot plate, and a system using, as a heat source, a heating medium such as silicone oil. A magnetic field intensity during the magnetic field application may be set in the range of 5000 [Oe] to 150000 [Oe], preferably in the range of 10000 [Oe] to 120000 [Oe]. As a result, the easy magnetization axes of the magnet material particles (crystal particles) contained in the processing sheet piece 123 are oriented in parallel alignment in directions along the parallel magnetic field 121, as designated by the reference signs 122 in FIG. 7(a). This magnetic field application step may be configured such that a magnetic field is simultaneously applied to a plurality of the processing sheet pieces 123. In this case, the parallel magnetic field 121 may be simultaneously applied, using a die having a plurality of cavities or a plurality of dies arranged side-by-side. The step of applying a magnetic field to the processing sheet piece 123 may be performed in concurrence with the heating step, or during a period after completion of the heating step and before solidification of the binder of the processing sheet piece 123.

Subsequently, the processing sheet piece 123 in which the easy magnetization axes of the magnet material particles thereof are oriented in parallel alignment as indicated by the arrowed lines 122 through the magnetic field application step depicted in FIG. 7(a) is taken out of the magnetic field application die, and transferred into a final shaping die 126 having a trapezoidal-shaped cavity 124 having an elongate length dimension as depicted in FIGS. 7(b) and 7(c), and a male die 127 having a convex shape corresponding to the cavity 124 is used to press the processing sheet piece 123 within the cavity 124 to cause the arc-shaped regions 7a, 8a at the opposite ends of the processing sheet piece 123 to be deformed so as to align linearly with the central linear region 6a to thereby form a sintering sheet piece 125 depicted in FIG. 7(b). This sintering sheet piece 125 corresponds to a second shaped body of the invention.

Through this shaping, the processing sheet piece 123 is formed into an elongated trapezoidal shape in which the arc-shaped regions 7a, 8a are deformed into a shape linearly continuous with the central linear region 6a, while being formed with inclined faces 125a, 125b at respective opposite ends thereof. In the sintering sheet piece 125 formed through the shaping step, the easy magnetization axes of the magnet material particles contained in the central linear region 6a maintained in a parallel orientation state in which they are oriented parallel to the thickness direction. On the other hand, in each of the end regions 7a, 8a, as a result of deforming the upwardly convexed shape into a linear shape continuous with the central linear region, the easy magnetization axes therein are oriented so as to be converged toward part of an upper side corresponding to each of the end regions, as depicted in FIG. 7(b).

The oriented sintering sheet piece 125 in which the easy magnetization axes of the magnet material particles thereof are oriented in the above manner is subjected to calcining treatment (decarbonizing) in a non-oxidizing atmosphere adjusted at atmospheric pressure, or a pressure greater or less than atmospheric pressure, e.g., at 0.1 MPa to 70 MPA, preferably at 1.0 Pa or 1.0 MPa, at a decomposition temperature of the binder for a holding time of several hours to several ten hours, e.g., 5 hours. In this treatment, it is recommended to use a hydrogen atmosphere or a mixed gas atmosphere of hydrogen and inert gas. In the case where the calcining treatment is performed in a hydrogen atmosphere, a supply amount of hydrogen during the calcining treatment is set, for example, to 5 L/min. The calcining treatment makes it possible to remove organic compounds contained in the binder by decomposing the organic compounds to monomers by a depolymerization reaction or other reactions, and releasing the monomers. That is, decarbonizing which is treatment for reducing an amount of carbon remaining in the sintering sheet piece 125 is performed. Further, it is preferable to perform the calcining treatment under conditions which enable the amount of carbon remaining in the sintering sheet piece 125 to become 2000 ppm or less, preferably 1000 ppm or less. This makes it possible to densely sinter the entire sintering sheet piece 125 through subsequent sintering to thereby suppress lowering of residual magnetic flux density and coercivity. In the case where a pressurization condition during the calcining treatment is set to a pressure greater than atmospheric temperature, it is desirable to set the pressure to 15 MPa or less. Further, the pressurization condition may be set to a pressure greater than atmospheric temperature, more specifically, to 0.2 MPa or more. In this case, an effect of reducing an amount of residual carbon can be particularly expected. Although a temperature to be set during the calcining treatment varies depending on a type of the binder, it may be set in the range of 250° C. to 600° C., preferably in the range of 300° C. to 500° C.

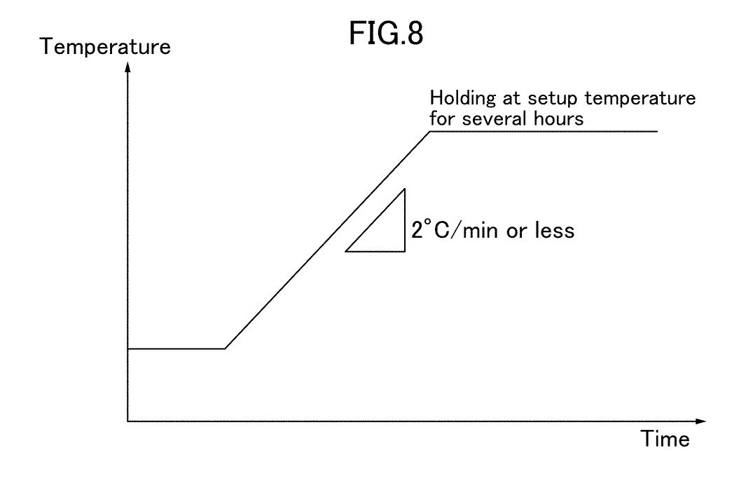

In the above calcining treatment, it is preferable to set a temperature rising speed to a smaller value, as compared to typical sintering treatment of a rare-earth magnet. Specifically, the temperature rising speed may be set to 2° C./min or less, e.g., 1.5° C./min. In this case, a good result can be obtained. Thus, the calcining treatment is performed such that the calcining temperature is increased at a given temperature rising speed of 2° C./min or less as depicted in FIG. 8, and, after reaching a predetermined setup temperature, i.e., a binder decomposition temperature, held at the setup temperature for several hours to several ten hours. As above, the temperature rising speed in the calcining treatment is set to a relatively small value, so that carbon in the entire sintering sheet piece 125 is removed in a step-by-step manner without being rapidly removed. This makes it possible to reduce an amount of residual carbon to a sufficient level to thereby increase the density of a permanent magnet-forming sintered body after sintering. That is, by reducing the amount of residual carbon, it is possible to reduce voids in a permanent magnet. When the temperature rising speed is set to about 2° C./min as mentioned above, the density of a permanent magnet-forming sintered body after sintering can be increased to 98% or more, e.g., 7.40 g/cm³ or more, and high magnet properties can expected in a magnet after magnetization.

Before the calcining treatment, deoiling treatment for volatilizing oil components such as an orientation lubricant and a plasticizer may be performed. Although a temperature to be set during the deoiling treatment varies depending on a type of the oil component contained, it may be set in the range of 60° C. to 120° C., preferably in the range of 80° C. to 100° C. In the deoiling treatment, a temperature rising speed may be set to 10° C./min or less, e.g., at 0.7° C./min. In this case, a good result can be obtained. Further, a better result can be obtained by performing the deoiling step in a reduced-pressure atmosphere. More specifically, it is preferable to perform the deoiling step under a reduced pressure of 0.01 Pa to 20 Pa, preferably 0.1 Pa to 10 Pa.

Subsequently, treatment for sintering the sintering sheet piece 125 calcined by the calcining treatment is performed. In this embodiment, as the sintering treatment, it is preferable to employ a uniaxial pressing-sintering method which comprises sintering the sintering sheet piece 125 while uniaxially pressing the sintering sheet piece 125 in a length direction of the sintering sheet piece 125 which is a direction perpendicular to the plane of the drawing sheet of FIG. 7, although a non-pressurized sintering method under a reduced pressure may be employed. In this method, the sintering sheet piece 125 is loaded in a sintering die (not depicted) having a cavity with the same cross-sectionally-trapezoidal shape as that designated by the reference sign “124” in FIG. 7(b). Then, after closing the die, the sintering sheet piece 125 is sintered while being pressed in the length direction of the sintering sheet piece 125 which is the direction perpendicular to the plane of the drawing sheet of FIG. 7. More specifically, a uniaxial pressing-sintering method is employed which comprises sintering the sintering sheet piece 125 while being pressed in the length direction, i.e., in the same direction as an axial direction of the rotor core 21 along which a rare-earth permanent magnet formed from the sintering sheet piece 125 is received in the magnet-insertion slot 24 depicted in FIG. 2. As this pressing-sintering technique, it is possible to employ any one of heretofore-known techniques such as hot press sintering, hot isostatic press (HIP) sintering, ultrahigh pressure synthesis sintering, gas pressure sintering, and spark plasma sintering (SPS). In particular, it is preferable to employ the hot press sintering in which a pressure can be applied in a uniaxial direction. During the sintering, it is preferable to set a pressing pressure, for example, in the range of 0.01 MPa to 100 MPa (preferably 0.01 MPa to 15 MPa), and heat the sheet piece up to 900° C. to 1000° C., e.g., 940° C., at a temperature rising speed of 3° C./min to 30° C./min, e.g., 10° C./min, under an atmosphere at a reduced-pressure of several Pa or less, then the temperature is held until the rate of change per 10 sec in a pressing direction becomes 0. This holding time is typically about 5 minutes. Subsequently, after cooling the sheet piece, a heat treatment is performed again in which the sheet piece is heated to 300° C. to 1000° C., and held at the temperature for 2 hours. As a result of the above sintering treatment, the rare-earth permanent magnet-forming sintered body 1 according to the present invention is produced from the sintering sheet piece 125. As above, the uniaxial pressing-sintering method capable of sintering the sintering sheet piece 125 while pressing it in the length direction makes it possible to suppress a situation where the orientations of the easy magnetization axes imparted to the magnet material particles in the sintering sheet piece 125 are changed. During the sintering step, almost the entirety of the resin material in the sinter processing sheet piece 125 evaporates, and an amount of residual resin is very small, if any. Preferably, the density of the sintered body for forming a rare-earth magnet to be obtained by the sintering treatment is 7.5 g/cm3 or more. An increase in density of the sintered body provides improved magnetic properties and mechanical strength.

It is desirable that, in a sintered body for forming a rare-earth magnet according to one embodiment of the present invention, each of a large number of magnet material particles has an aspect ratio of 2 or less, preferably 1.8 or less. This is because, if the aspect ratio is excessively large, the mechanical strength of the sintered body for forming a rare-earth magnet tends to be deteriorated.

This rare-earth permanent magnet-forming sintered body 1 is inserted into the magnet-insertion slot 24 of the rotor core 21 depicted in FIG. 2, in an unmagnetized state. Then, the rare-earth permanent magnet-forming sintered body 1 inserted into the magnet-insertion slot 24 is subjected to magnetization along the easy magnetization axes, i.e., C axes, of the magnet material particles included therein. Specifically, a plurality of the rare-earth permanent magnet-forming sintered bodies 1 are inserted, respectively, into a plurality of the slots 24 of the rotor core 21, and subjected to magnetization such that an N-pole and an S-pole are alternately arranged along a circumferential direction of the rotor core 21. As a result, the permanent magnet 1 can be produced. For magnetization of the rare-earth permanent magnet-forming sintered body 1, it is possible to use any theretofore-known magnetization means, such as a magnetizing coil, a magnetizing yoke, or a capacitor-type magnetizing power supply device. Alternatively, the rare-earth permanent magnet-forming sintered body 1 may be magnetized to form a rare-earth permanent magnet before being inserted into the slot 24, and then this magnetized magnet may be inserted into the slot 24.

The rare-earth permanent magnet-forming sintered body according to the present invention has a carbon content of 500 ppm or less, wherein a large number of magnet material particles therein have an average particle size of 2 μm or less. Thus, a magnet resulting from magnetization has high coercivity. For example, in the present invention, the coercivity (Hcj) of an obtainable magnet is 5.0 kOe, more preferably 10 kOe, further preferably 15.0 kOe, further more preferably 17.0 kOe. Further, in terms of residual magnetic flux density (Br), squareness ratio (Hk/Hcj) and magnetic energy product ((BH) max), the obtainable magnet is not inferior to conventional magnets.

In the embodiment described above, by shaping a composite material which is a mixture of magnet material particles and a binder, it becomes possible to orient easy magnetization axes such that they are adequately converged toward a surface of an end region which is expected to take measures against demagnetization. Thus, after magnetization, it becomes possible to adequately concentrate a magnetic flux to ensure demagnetization resistance and prevent variation in magnetic flux density. Further, a mixture with a binder is shaped, so that it becomes possible to improve a degree of orientation without turning of the magnet material particles after orientation, as compared to the case of employing a powder compacting process. In the orientation method based on applying a magnetic field to a composite material which is a mixture of magnet material particles and a binder, a number of turns of a winding for conducting current to form a magnetic field can be appropriately increased, so that it becomes possible to ensure a large magnetic field intensity during the magnetic field orientation and to perform the magnetic field application under a static magnetic field for a long period of time. This makes it possible to realize a high degree of orientation with less variation. Further, by correcting an orientation direction after the orientation, it becomes possible to ensure orientation in a highly-oriented state with less variation.

The capability of realizing a high degree of orientation with less variation leads to a reduction of variation in shrinkage due to sintering. Thus, it is possible to ensure uniformity in product shape after sintering. As a result, it can be expected to reduce a burden of outer shape processing after sintering, thereby contributing to great improvement in stability of high-volume production. Further, in the magnetic field orientation step, magnetic field orientation is performed by applying a magnetic field to a composite material which is a mixture of magnet material particles and a binder, and then deforming, to a shaped body, the composite material after the magnetic field application to thereby control directions of easy magnetization axes. That is, a composite material subjected to magnetic field orientation once is deformed to correct the orientation direction. This makes it possible to orient easy magnetization axes such that they are adequately converged toward a target region for demagnetization measures. As a result, it becomes possible to achieve orientation in a highly-oriented state with less variation. After forming the composite material into a processing sheet piece and applying a magnetic field to the processing sheet piece, the resulting processing sheet piece is deformed to obtain a sintering sheet piece. Thus, orientation directions can be corrected in conjunction with the deformation step, so that it becomes possible to perform both of a permanent magnet shape-forming step and an orientation step by a single step, thereby improving productivity. Further, as previously mentioned, in a rotary electric machine provided with a permanent magnet formed by magnetizing a sintered body, it becomes possible to prevent a problem of lowering in torque or power generation amount, even when an external magnetic field exerting a demagnetization action is applied to an end region of a permanent magnet obtained by magnetizing the permanent magnet-forming sintered body 1. For example, in the above embodiment, although the permanent magnet-forming sintered body 1 is formed in a trapezoidal shape in cross-section, it may be formed in another shape such as an arch shape or a half-moon shape, depending on intended purpose. Further, a shape of a magnetic field distribution to be realized may be appropriately modified depending on a shape and intended purpose of an obtainable permanent magnet.

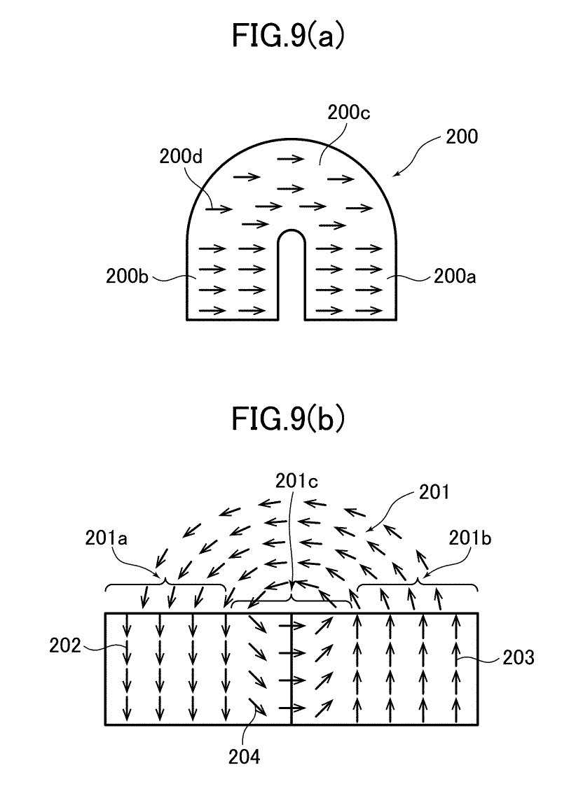

FIGS. 9(a) and 9(b) are diagrams depicting a second embodiment of the present invention, similar to FIGS. 7(a) and 7(b). As depicted in FIG. 9(a), a first shaped body 200 formed from the green sheet 119 has an inverted U shape which comprises a pair of legs 200a, 200b, and a semicircular portion 200c between the legs 200a, 200b. As a result of application of an external parallel magnetic field, the easy magnetization axes of the magnet material particles in the first shaped body 200 are oriented in parallel relation to each other in a rightward direction in FIG. 9(a) as indicated by the arrowed lines 200d in FIG. 9(a). This inverted U-shaped first shaped body 200 is deformed into a linear shape as depicted in FIG. 9(b) under a given temperature condition, to form a second shaped body 201. Preferably, the deformation from the first shaped body 200 to the second shaped body 201 is preferably performed little by little in a stepwise manner, so as not to cause excessively forced deformation. For this purpose, it is preferable to preliminarily prepare a plurality of shaping dies each having a cavity corresponding to a respective one of a plurality of shapes of the first shaped body in various deformation stages, and subject the first shaped body to shaping within each of the shaping dies. In the second shaped body 201 depicted in FIG. 9(b) the easy magnetization axes of the magnet material particles of the second shaped body 201 are oriented such that, in one end region 201a, they have a parallel orientation directed downwardly in FIG. 9(b) as indicated by the arrowed lines 202 in FIG. 9(b), whereas, in the other end region 201b, they have a parallel orientation directed upwardly in FIG. 9(b) as indicated by the arrowed lines 203 in FIG. 9(b). In a central region 201c between the opposite end regions 201a, 201b, an upwardly-concave semicircular shaped orientation is formed as indicated by the arrowed lines 204 in FIG. 9(b). In a rare-earth permanent magnet formed by magnetizing a sintered body for forming a rare-earth magnet obtained by sintering the second shaped body 201, a magnetic flux flow is generated which exits from an upper surface of the region 201b at one end of the magnet to an outside of the magnet, and, after following an arc-shaped path, enters into the magnet from an upper surface of the other end region 201a on the other end of the magnet. Therefore, this magnet is capable of generating a magnetic flux flow intensified on one side of the magnet. This makes it possible to obtain a permanent magnet suitable for use, for example, in a linear motor.

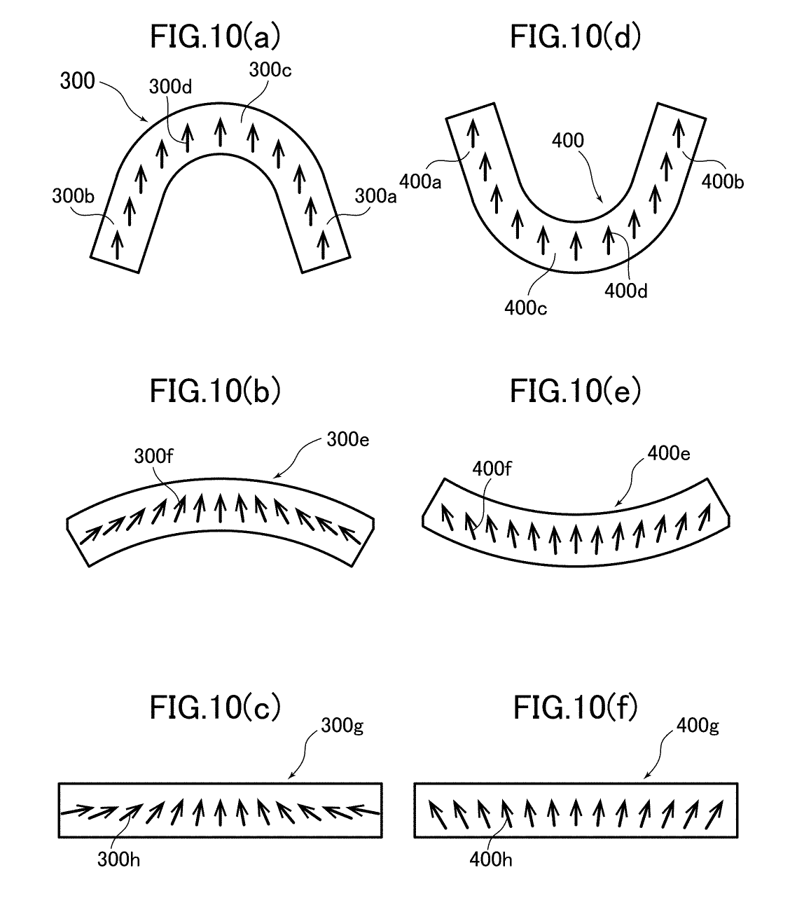

FIG. 10(a) depicts a third embodiment of the present invention, wherein a first shaped body 300 has a shape which comprises a pair of legs 300a, 300b and a semicircular portion 300c, wherein ends of the legs 300a, 300b on a side opposite to the semicircular portion 300c are spread in a width direction, as compared to the inverted U shape of the first shaped body 200 depicted in FIG. 9(a). An application direction of a parallel magnetic field is directed upwardly. Thus, the easy magnetization axes of the magnet material particles contained in the first shaped body 300 are oriented upwardly in parallel relation to each other as indicated by the arrowed lines 300d in FIG. 10(a). The first shaped body 300 is deformed into an arc shape depicted in FIG. 10(b) to form a second shaped body 300e. The easy magnetization axes 300f of the magnet material particles contained in the second shaped body 300e are oriented such that the orientation angle gradually increases toward a width-directional central region of the second shaped body 300e to cause the easy magnetization axes 300f to be converged toward the central region, as depicted in FIG. 10(b). In this way, it is possible to form a sintered body having given orientations of the easy magnetization axes for an arc-shaped segment magnet with a polar anisotropy orientation. FIG. 10(c) depicts one modification of the second shaped body depicted in FIG. 10(b), wherein a second shaped body 300g is formed by deforming the first shaped body 300 into an elongate rectangular parallelepiped shape. In this modified embodiment, the orientations of the easy magnetization axes 300h in the second shaped body 300g are similar to those depicted in FIG. 10(b). An arc-shaped segment magnet with a polar anisotropy orientation, obtainable by magnetizing a sintered body formed by sintering the arc-shaped segment with the polar anisotropy orientation depicted in FIG. 10(b), can be used for constructing a surface permanent magnet motor (SPM motor), wherein a plurality of the magnets are arranged side-by-side along a periphery of a rotor in a circumferential direction of the motor.

FIG. 10(d) depicts a first shaped body 400, wherein the first shaped body 400 is obtained by turning upside down the first shaped body 300 depicted in FIG. 10(a) so as to have a leg-spread U shape comprising a pair of legs 400a, 400b, and a semicircular portion 400c between the legs 400a, 400b. An external parallel magnetic field is directed upwardly in FIG. 10(d). As a result, the easy magnetization axes of the magnet material particles contained in the first shaped body 400 have a parallel orientation directed upwardly as indicated by the arrowed line 400d in FIG. 10(d). FIG. 10(e) depicts a second shaped body 400e obtained by deforming the first shaped body 400 into an arc shape having a curvature radius greater than that of the semicircular portion 400c. The easy magnetization axes 400f of the magnet material particles contained in the second shaped body 400e are oriented such that they are spread from a width-directional central region toward each of opposite ends of the second shaped body 400e, as depicted in FIG. 10(e). FIG. 10(f) depicts a second shaped body 400g which is one modification of the second shaped body 400e, wherein the second shaped body 400g is formed by deforming the first shaped body 400 into an elongate a rectangular parallelepiped shape. In this modified embodiment, the orientations of the easy magnetization axes in the second shaped body 400g are similar to those depicted in FIG. 10(e).

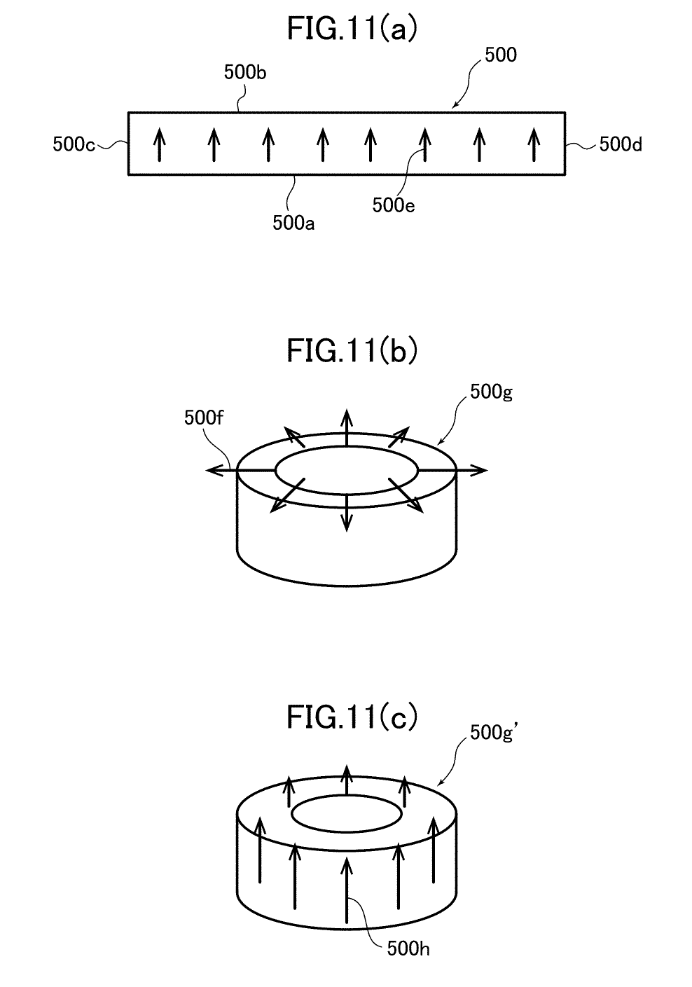

FIGS. 11(a) and 11(b) are a side view and a perspective view depicting a method of producing an annular-shaped, radially-oriented sintered body for forming a rare-earth magnet, wherein the easy magnetization axes of the magnet material particles thereof are oriented in a radial direction. FIG. 11(a) depicts a first shaped body 500 which is a rectangular parallelepiped body having a certain length in a direction perpendicular to the plane of the drawing sheet of FIG. 11(a) and having a cross-sectionally approximately rectangular shape. The first shaped body 500 has: a lower surface 500a, i.e., a first surface; an upper surface 500b, i.e., a second surface, parallel to the lower surface 500a; and two end faces 500c, 500d at opposite ends thereof. An external parallel magnetic field is applied upwardly to the first shaped body 500, such that the easy magnetization axes of the magnet material particles contained in the first shaped body are oriented in a direction from the lower surface 500a toward the upper surface 500b in parallel relation to each other, as designated by the reference sign 500e in FIG. 11(a). This first shaped body 500 is bent in an annular shape within the plane of the drawing sheet of FIG. 11(a) such that the upper surface 500b becomes an outer peripheral surface, and the lower surface 500a becomes an inner peripheral surface. In advance of the bending, each of the end faces 500c, 500d is obliquely cut to enable the two end faces to be adequately butted against each other so as to form an annular body. Then, the butted end faces 500c, 500d are thermally bonded together. Through the bending and the thermal bonding of the end faces, an annular-shaped second shaped body 500g depicted in FIG. 11(b) is formed. As depicted in FIG. 11(b), in the second shaped body 500g, the easy magnetization axes 500f of the magnet material particles have a radial orientation directed radially outwardly. Alternatively, referring to FIG. 11(c), the first shaped body 500 depicted in FIG. 11(a) is bent in an annular shape in a direction perpendicular to the plane of the drawing sheet of FIG. 11(a), i.e., in a length direction, such that the front or rear surfaces becomes an inner peripheral surface. In this case, in advance of the bending, each of the end faces 500c, 500d is obliquely cut in the length direction to enable the two end faces to be adequately butted against each other so as to form an annular body. Then, the butted end faces 500c, 500d are thermally bonded together. Through the bending and the fusion bonding of the end faces, an annular-shaped second shaped body 500g′ depicted in FIG. 11(c) is formed. As depicted in FIG. 11(c), in the second shaped body 500g′, the easy magnetization axes 500h of the magnet material particles have an axial orientation parallel to a radial direction of the annular body.

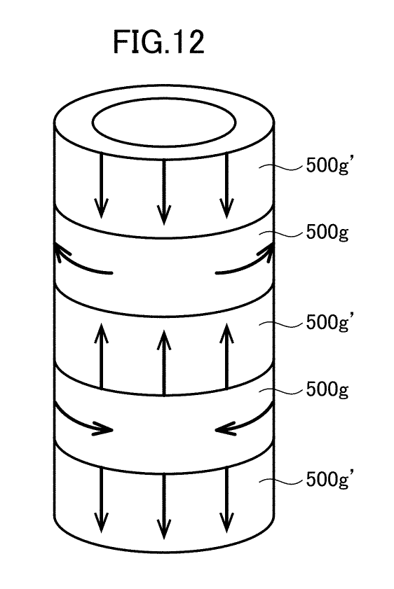

FIG. 12 depicts a Halbach array of magnets formed by alternately stacking two types of sintered rare-earth permanent magnets obtained by magnetizing respective rare-earth magnet-forming sintered bodies prepared by sintering the radially-oriented annular second shaped body 500g depicted in FIG. 11(b) and the axially-oriented annular second shaped body 500g′ depicted in FIG. 11(c). A Halbach array of annular magnets is regarded as a promising element for use in a synchronized linear motor or the like. For example, in U.S. Pat. No. 5,705,902 B (Patent Document 5), there is disclosed an example in which this type of magnet is used in a serially-connected motor generator, and, in JP 2013-215021 A (Patent Document 6), there is disclosed an example of another application. However, it is not easy for such conventional techniques to produce a radially-oriented or axially-oriented annular magnet, stably at low cost. In contrast, the technique of the present invention makes it possible to easily produce radially-oriented and axially-oriented annular magnets with high magnetic properties, as mentioned above.

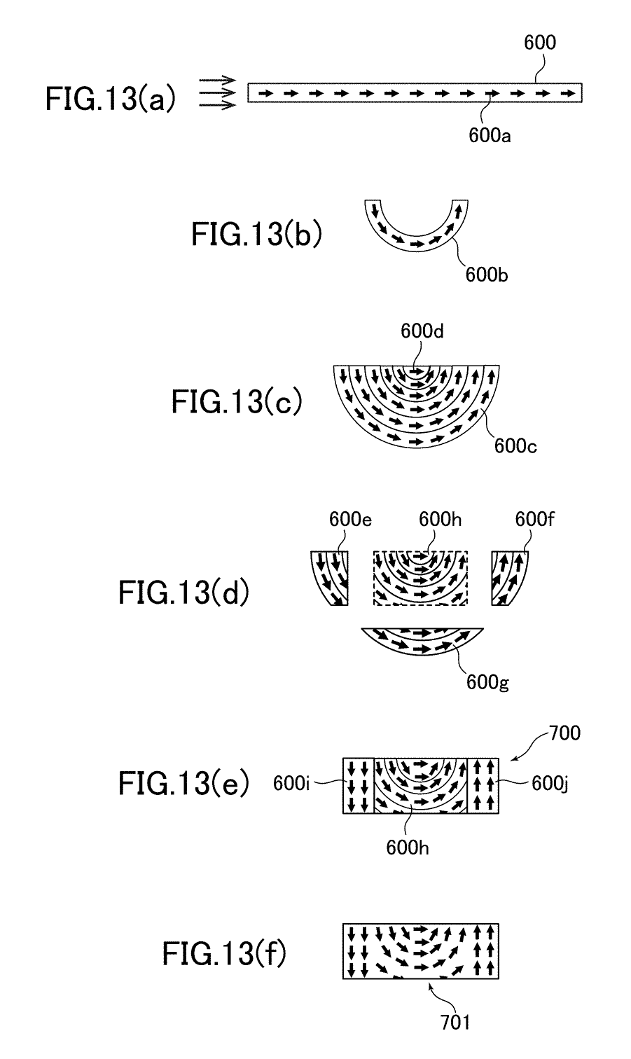

FIG. 13 depicts a method for producing a rare-earth sintered magnet having the orientations of easy magnetization axes similar to those in the rare-earth sintered magnet depicted in FIG. 9(b), in a sixth embodiment of the present invention. In this embodiment, as depicted in FIG. 13(a), an external parallel magnet field is applied to a green sheet 600 in a direction parallel to a width direction of the green sheet 600. As a result of the application of the external parallel magnet field, the easy magnetization axes of the magnet material particles contained in the green sheet 600 are oriented in the width direction of the green sheet 600, as indicated by the arrowed lines 600a in FIG. 13(a). Subsequently, the green sheet 600 whose easy magnetization axes are oriented in this manner is inserted in a die having a semicircular arc-shaped cavity, and heated up to a softening temperature of a resin component of the green sheet 600. Then, in this state, the green sheet 600 is deformed into a semicircular arc shape, and formed as an arc-shaped member 600b as depicted in FIG. 13(b). In this step, a plurality of arc-shaped members having curvature radii each different by a thickness of the arc-shaped member 600b are formed. Then, the plurality of arc-shaped members having different curvature radii are laminated and thermally bonded together to form a semicircular intermediate member 600c, as depicted in FIG. 13(c). In this step, one arc-shaped member 600d used at a central position of the arcs can be formed by cutting out it directly from the green sheet 600.

As depicted in FIG. 13(d), the semicircular intermediate member 600c is processed such that width-directionally opposite ends 600e, 600f and a lower portion 600g thereof are cut off to thereby cut out a rectangular portion having a given thickness dimension and a given width dimension, as a sintering member piece 600h. Then, a sintering member piece 600i having downwardly-oriented easy magnetization axes and a sintering member piece 600j having upwardly-oriented easy magnetization axes are thermally bonded, respectively, to opposite lateral ends of the sintering member piece 600h to form a sintering magnet member 700. This sintering magnet member 700 is inserted into a sintering die having a cavity having a corresponding shape, and subjected to sintering under given sintering conditions to form a sintered body for forming a rare-earth magnet 701. During the sintering, a pressing pressure may be applied to or needs not be applied to the sintering magnet member 700 in a length direction thereof, i.e., in a direction perpendicular to the plane of the drawing sheet of FIG. 13(e). The sintered body for forming a rare-earth magnet 701 obtained in this manner is formed such that the orientations of the easy magnetization axes therein have an upwardly-convexed arc pattern in a central region, and have downward and upward patterns in opposite lateral end regions, as depicted in FIG. 13(f). A rare-earth sintered magnet obtained by magnetizing the sintered body 701 is capable of generating the same magnetic flux as that depicted in FIG. 9(b).

### EXAMPLES

Examples of the present invention will now be described. In Examples presented here, materials in the following Table 1 and alloys in Table 2 were used.

TABLE 1

| | | | Tg | Molecular Weight |
|---|---|---|---|---|
| Material | Manufacturer | Product Name | (° C.) | Mw |
| 1-Octadecyne | Wako Pure Chemical Industries, | — | 30 | |
| | Ltd. | | | |
| 1-Octadecene | Wako Pure Chemical Industries, | — | 15 | |
| | Ltd. | | | |
| Oleyl Alcohol | New Japan Chemical Co., Ltd. | RIKACOL 90B | 3 | |
| PIB | BASF SE | oppanol B100 | −68 | 1.1 × 10⁶ |
| PIB | BASF SE | oppanol B150 | −68 | 2.6 × 10⁶ |

TABLE 2

| Alloy | | | | | | | | | |
|---|---|---|---|---|---|---|---|---|---|
| Composition | Nd | Fe | B | Pr | Cu | Ga | Nb | Co | Al |
| A | 23.00 | Remainder | 1.00 | 6.75 | 0.10 | 0.10 | 0.20 | 2.00 | Small Amount |
| B | 25.25 | Remainder | 1.01 | 6.75 | 0.13 | 0.13 | 0.20 | 2.00 | 0.100 |
| C | 24.85 | Remainder | 1 | 6.75 | 0.10 | 0.10 | 0.2 | 2.00 | Small Amount |

### Example 1

A rare-earth sintered magnet was produced in the following manner.

### <Coarse Pulverization>

At room temperature, hydrogen was adsorbed in an alloy obtained by a strip casting process and having an alloy composition A (Nd: 23.00 wt %, Pr: 6.75 wt %, B: 1.00 wt %, Ga: 0.1 wt %, Nb: 0.2 wt %, Co: 2.0 wt %, Cu: 0.1 wt %, remainder including Fe and other unavoidable impurities), and held under 0.85 MPa for 1 day. Subsequently, the alloy was held under 0.2 MPa for 1 day while being cooled by liquefied Ar to induce hydrogen cracking.

### <Fine Pulverization>

1.5 kg of Zr beads (2φ) was mixed with 100 weight parts of the hydrogen-cracked coarse alloy powder, and the resulting mixture was input into a ball mill having a tank volume of 0.8 L (product name: Attritor 0.8 L, manufactured by Nippon Coke & Engineering Co., Ltd.), to pulverize the hydrogen-cracked coarse alloy powder at a rotational speed of 500 rpm for 2 hours. During the pulverization, benzene was added in an amount of 10 weight parts as a pulverization aid, and liquefied Ar was used as a solvent.

### <Kneading>

6.7 weight parts of 1-octadecyne and 40 weight parts of a toluene solution (10 weight %) of polyisobutylene (PIB) (B100, manufactured by BASF SE) were added to 100 weight parts of the pulverized alloy particles, and the resulting mixture was subjected to stirring under reduced pressure and at 70° C., using a mixer (device name: TX-0.5, manufactured by INOUE MFG Inc.). Then, after toluene was distiled away, the resulting mixture was further kneaded for 2 hours under the same conditions to prepare a clayey composite material.

### <Formation of First Shaped Body>

The composite material prepared in the kneading step was put in a die made of stainless steel (SUS) and formed with a cavity having a size of 44 mm×4 mm×4 mm, to form a first shaped body.

### <Magnetic Field Orientation>

The prepared first shaped body was subjected to orientation treatment using a superconducting solenoid coil (device name: JMTD-12T100, manufactured by JASTEC). This orientation treatment was performed by applying an external magnetic field of 7 T, at 80° C. for 10 minutes. The magnetic field was applied parallel to a thickness direction of the first shaped body having a thickness of 4 mm. Subsequently, the first shaped body was subjected to demagnetization treatment by applying a reverse magnetic field thereto. The application of the reverse magnetic field was performed by gradually reducing a magnetic field intensity toward a zero magnetic field, specifically by changing the magnetic field intensity from −0.2 T to +0.18 T and then to −0.16 T.

### <Calcination (Decarbonization)>

The shaped body after being subjected to the magnetic field orientation was taken out of the stainless steel die, and subjected to decarbonization treatment in a high-pressure and high-temperature hydrogen atmosphere (0.8 MPa). In the decarbonization treatment, the shaped body was heated from room temperature to 350° C. by taking 8 hours, and then held at 350° C. for 2 hour.

### <Sintering>

After the decarbonization, the resulting shaped body was subjected to sintering in a reduced-pressure atmosphere. In the sintering, the shaped body was heated up to 950° C. by taking 2 hours, and then held at 950° C. for 2 hour. After the sintering, the resulting shaped body was cooled to room temperature.

### <Annealing>

The obtained sintered body was heated from room temperature to 500° C. by taking 0.5 hours, and then held at 500° C. for 1 hour. Subsequently, the sintered body was subjected to annealing by means of rapid cooling.

### Examples 2 to 14

Except that the above conditions were changed to those described in Table 2, sintered bodies in Examples 2 to 14 were obtained in the same manner as that in Example 1.

Jet mill pulverization in Table 2 was performed in the following manner. 1 weight part of methyl caproate was mixed with 100 weight parts of the hydrogen-cracked coarse alloy powder, and then the hydrogen-cracked coarse alloy powder was pulverized by a helium jet mill pulverizer (device name: PJM-80HE, manufactured by Nippon Pneumatic Mfg. Co., Ltd. (NPK)). The resulting pulverized alloy particles were separated and collected by a cyclone system, and a ultrafine powder was removed. During the pulverization, a feed rate was set to 1 kg/h, and an introduction pressure and a flow rate of He gas were set, respectively, to 0.6 MPa and 1.3 m³/min. Further, an oxygen concentration was 1 ppm or less, and a dew point was −75° C. or less.

On the other hand, in the case where oleyl alcohol was used during the kneading, a rare-earth sintered magnet was produced in the following manner. 40 weight parts of 1-octene was added to 100 weight parts of the pulverized alloy powder, and the resulting mixture was subjected to stirring under heating at 60° C. for 1 hour using a mixer (device name: TX-0.5, manufactured by INOUE MFG Inc.). Then, after 1-octene and its reaction product were distiled away under reduced pressure and heating, the allow powder was subjected to dehydrogenation treatment. Further, oleyl alcohol, 1-Octadecene and a toluene solution (10 weight %) of polyisobutylene (PIB) (B100, manufactured by BASF SE) described in Table 3 were added thereto. Then, after toluene was distiled away under conditions of reduced pressure-heating-stirring at 70° C., the resulting mixture was kneaded for 2 hours under reduced pressure to prepare a clayey composite material.

Treatment conditions in each step in Examples 2 to 14 are collectively presented in Table 3.

TABLE 3

| | | | | | Binder Composition (weight Part) | | | | |
|---|---|---|---|---|---|---|---|---|---|
| | | | Jet Mill | | | | | 10 wt % | Sintering |
| | Alloy | Pulverization | Feed Rate | dehydrogenation | | Oley | | PIB(B100) | Temperature |
| | Composition | System | (kg/h) | treatment | Octadecyne | Alcohol | Octadecene | solution | (° C.) |
| Example 1 | A | Ball mill | — | Without | 6.7 | — | — | 40 | 960 |
| Example 2 | A | Ball mill | — | Without | 6.7 | — | — | 40 | 960 |
| Example 3 | A | Ball mill | — | Without | 6.7 | — | — | 40 | 960 |
| Example 4 | A | Ball mill | — | Without | 6.7 | — | — | 40 | 960 |
| Example 5 | A | Ball mill | — | Without | 6.7 | — | — | 40 | 960 |
| Example 6 | A | Ball mill | — | Without | 6.7 | — | — | 40 | 960 |
| Example 7 | A | Ball mill | — | Without | 6.7 | — | — | 40 | 960 |
| Example 8 | A | Ball mill | — | Without | 6.7 | — | — | 40 | 960 |
| Example 9 | A | Ball mill | — | Without | 6.7 | — | — | 40 | 960 |
| Example | A | Ball mill | — | Without | 6.7 | — | — | 40 | 960 |
| 10 | | | | | | | | | |
| Example | B | Jet mill | 0.3 | With | — | 0.8 | 4.4 | 50 | 900 |
| 11 | | | | | | | | | |
| Example | B | Jet mill | 2.5 | With | — | 0.5 | 4.1 | 50 | 1000 |
| 12 | | | | | | | | | |
| Example | C | Jet mill | 0.9 | With | — | 0.5 | 4.1 | 50 | 950 |
| 13 | | | | | | | | | |
| Example | C | Jet mill | 1.5 | With | — | 0.5 | 4.1 | 50 | 950 |
| 14 | | | | | | | | | |

### <Carbon Content, Oxygen Content, Nitrogen Content, Hydrogen Content>

A carbon content in the obtained sintered body was analyzed using a carbon content analyzer (device name: EMA620SP, manufactured by Horiba, Ltd.), and an oxygen content and a nitrogen content in the obtained sintered body were analyzed using

an oxygen-nitrogen analyzer (device name: PC436, manufactured by LECO Corporation). Further, a hydrogen content in the obtained sintered body was analyzed using a hydrogen analyzer (device name: RH404, manufactured by LECO Corporation).

After a surface of the sintered body was subjected to grinding to remove an oxide layer, the resulting sintered body was pulverized into a fine power having a particle size of several ten μm within a glove box. The obtained pulverized powder was enclosed in a Ni pan (LECO Japan Corporation) in the case of the oxygen content-nitrogen content analysis or in a Sn pan (manufactured by LECO Corporation; φ5.0 mm/H 13 mm) in the case of the hydrogen content analysis, in an amount of about 30 to 40 mg, to form a test sample. In the carbon content analysis, the obtained pulverized powder was directly put in the analyzer, in an amount of about 0.2 g, and analyzed. Each of the analyses was performed twice, and an average of obtained results was employed as an analysis value.

### <Pulverized Particle Size>

A particle size of finely-pulverized particles was measured using a laser diffraction/scattering particle size distribution measuring device (device name: LA950, manufactured by Horiba Ltd.).

Specifically, the finely-pulverized particles were slowly oxidized, and then several hundred mg of the slowly-oxidized particles was uniformly mixed with silicone oil (product name: KF-96H-Million cs, manufactured by Shin-Etsu Chemical Co., Ltd.) to form a paste. Then, the paste was sandwiched between two quartz glass plates to form a test sample (HORIBA Paste method).

In a graph of particle size distribution (volume %), a value at D50 was defined as an average particle size. In the case where the particle size distribution has double peaks, D50 was calculated only for the peak value having a smaller particle size to determine the average particle size.

### <Sintered Particle Size>

A surface of the obtained sintered body was subjected to a surface treatment by SiC paper polishing, buffing and milling, and then a sintered particle size of the sintered body was analyzed using an SEM (device name: JSM-7001F, manufactured by JEOL Ltd.) equipped with an EBSD detector (device name: AZtecHLK EBSD NordlysNano Integrated, manufacturing by Oxford Instruments plc), or an electron scanning microscope (SUPRA40VP manufactured by Zeiss) equipped with an EBSD detector manufactured by EDAX Inc., (Hikari High Speed EBSD Detector). A view angle was set such that at least 200 particles fall therewithin, and a step was set to 0.1 to 1 μm. When the particle size is relatively large, the step is preferably set to about 1/10 of the particle size.

Analysis data was analyzed using Chanel 5 (manufactured by Oxford Instruments) or OIM analyzing software version 5.2 (manufactured by EDAX Inc.), and, as regards determination of a grain (crystal particle) boundary, a portion where a deviation angle in crystal orientation is 2° or more is determined as a grain boundary layer. Only a main phase was extracted, and a number-average value of circle-equivalent diameters of the grains in the main phase was defined as a sintered particle size.

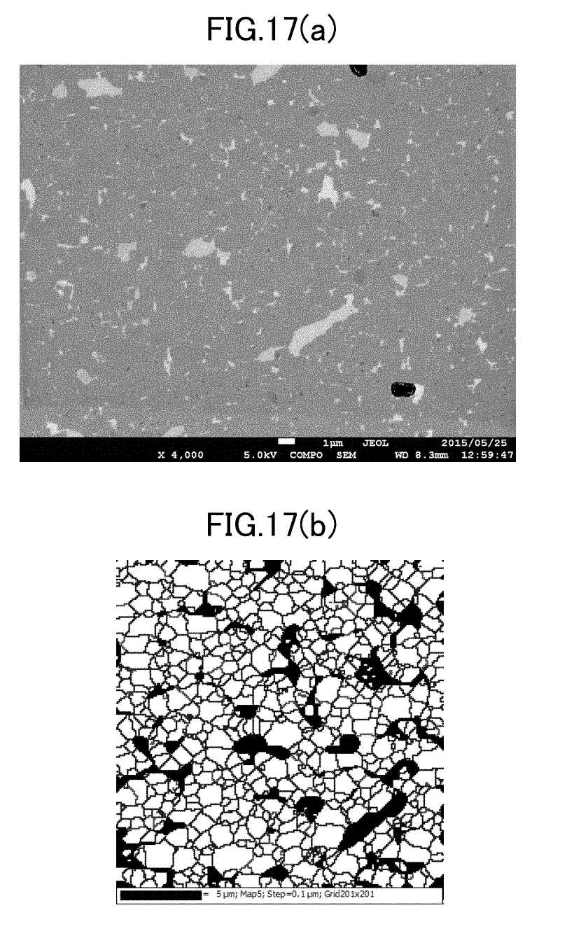

FIG. 17 presents a specific technique to be used when the sintered particle size is measured with regard to the magnet material particles in Example 11. From SEM observation as depicted in FIG. 17(a), in a 20 μm measurement area, a grain boundary was determined by EBSD analysis, and, except for a region (the blacked-out region in FIG. 17(b)) in which the EBSD analysis failed to read a crystal orientation, the particle size was determined in each grain boundary layer segmented by a line.

### <Aspect Ratio>

With regard to an aspect ratio of each sintered particle of the obtained sintered body, in a rectangle circumscribing the particle, the longest side (a) and the shortest side (b) were calculated, and the ratio of (a) to (b) was defined as an aspect ratio (a/b). The (a) and (b) were determined by analyzing a grain boundary extracting image based on

EBSD, using ImageJ (developed by Wayne Rasband).

### <Evaluation of Magnetic Properties>

The obtained sintered body was subjected to polishing, and then subjected to measurements of coercivity (Hcj), residual magnetic flux density (Br), squareness ratio (Hk/Hcj), and magnetic energy product ((BH) max), using a BH tracer (device name: TRF-5BH-25, manufactured by TOEI Industry CO., Ltd.).

Results of the evaluation of Examples 1 to 14 are presented in Table 4.

TABLE 4

| | | | Sintered | | | | | | | | | | |
|---|---|---|---|---|---|---|---|---|---|---|---|---|---|
| | | Pulverized | Particle | | | | | | | | | | |
| | Alloy | Particle | Size (μm) | | Aspect | C | O | N | H | Hcj | Br | Hk/Hcj | (BH)max |
| | Composition | Size (μm) | Av. | σ | Ratio | ppm | ppm | ppm | ppm | (kOe) | (T) | (%) | (Goe) |
| Example 1 | A | about 1.1 | 0.9 | | 1.5 | 60 | | | | 17.7 | | | |
| Example 2 | A | about 1.1 | 0.9 | | 1.5 | 200 | | | | 17.9 | | | |
| Example 3 | A | about 1.1 | 0.9 | | 1.5 | 200 | 1200 | 200 | 800 | 18.1 | 1.4 | 97 | 46.0 |
| Example 4 | A | about 1.1 | 0.9 | | 1.5 | 200 | 1700 | 300 | 1000 | 17.8 | 1.4 | 95 | 46.6 |
| Example 5 | A | about 1.1 | 0.9 | | 1.5 | 250 | 1100 | 200 | 900 | 18.1 | 1.4 | 97 | 46.0 |
| Example 6 | A | about 1.1 | 0.9 | | 1.5 | 250 | 900 | 200 | 600 | 18.0 | 1.4 | 96 | 45.6 |
| Example 7 | A | about 1.1 | 0.9 | | 1.5 | 300 | 1700 | 300 | 1300 | 18.1 | 1.4 | 97 | 45.9 |
| Example 8 | A | about 1.1 | 0.9 | | 1.5 | 330 | | | | 17.1 | | | |
| Example 9 | A | about 1.1 | 0.9 | | 1.5 | 430 | 1300 | 250 | 1500 | 17.5 | 1.4 | 97 | 46.3 |
| Example | A | about 1.1 | 0.9 | | 1.5 | 470 | 1300 | 250 | 1300 | 17.8 | 1.4 | 95 | 46.6 |
| 10 | | | | | | | | | | | | | |
| Example | B | 0.8 | 0.7 | 0.4 | 1.7 | 110 | 4300 | 150 | 300 | 17.1 | 1.37 | 87 | 44.4 |
| 11 | | | | | | | | | | | | | |
| Example | B | 1.9 | 1.4 | 0.8 | 1.6 | 330 | 2200 | 100 | 400 | 17.2 | 1.39 | 97 | 45.7 |
| 12 | | | | | | | | | | | | | |
| Example | C | about | 0.7 | 0.4 | 1.6 | 380 | 3000 | 100 | 200 | 20 | 1.38 | 96 | 45.5 |
| 13 | | 1 um | | | | | | | | | | | |
| Example | C | about | 1.1 | 0.7 | 1.7 | 410 | 2500 | 50 | 300 | 18.8 | 1.39 | 96 | 46.1 |
| 14 | | 1 um | | | | | | | | | | | |

In each of Example 1 to Example 14, it could be ascertained that the carbon content of the sintered body for forming a rare-earth magnet is 500 ppm or less, and the average particle size of the magnet material particles is 2 μm or less, wherein a magnet obtained by magnetizing the sintered body for forming a rare-earth magnet has a high coercivity (Hcj) of 17.0 kOe, and is not inferior to conventional magnets, in terms of residual magnetic flux density (Br), squareness ratio (Hk/Hcj), and magnetic energy product ((BH) max).

### Example 15

Except that, after magnet field orientation, the formation of a first shaped body, the formation of a second shaped body and the deoiling were performed in the following manner, and the above conditions were changed to those described in Tables 5 and 6, a sintered body in Example 15 was obtained in the same manner as that in Example 1.

### <Formation of First Shaped Body>

The composite material prepared in the kneading step was put in a die made of stainless steel (SUS) and formed with a cavity conforming to the shape depicted in FIG. 7(a) (a curvature radius of a portion corresponding to a part of the first surface of each of the end regions 7a, 8a is 21.50 mm, and a curvature radius of a portion corresponding to a part of the second surface of each of the end regions 7a, 8a is 19.8 mm).

### <Formation of Second Shaped Body>

The first shaped body after being subjected to the demagnetization treatment was taken out of the stainless steel die, and put in a negative die having a cavity in which a curvature radius of a portion thereof corresponding to a part of the second surface of each of the end regions 7a, 8a is 50.00 mm. Then, the first shaped body was pressed and deformed by a positive die having a die surface in which a curvature radius of a region thereof corresponding to the first surface is 50.00 mm, to thereby form an intermediate shaped body. Subsequently, the intermediate shaped body was put in a negative die having a cavity corresponding to a second shaped body, and pressed and deformed by a positive die having a die surface corresponding to a first surface of the second shaped body, to thereby form the second shaped body. Both of the deformation to the intermediate shaped body and the deformation to the second shaped body were performed under a temperature condition of 60° C. After completion of the deformation, the shaped body was taken out of the stainless steel die, and inserted in a die made of graphite and formed with a cavity having the same shape as that of the shaped body. A length of the cavity of the graphite die in the length direction is greater than a length of the formed compound in the length direction by about 20 mm, so that the shaped body is inserted such that it is located in a central region of the cavity. A BN (boron nitride) powder was applied as a release agent onto the graphite die.

### <Deoiling Step>

The shaped body inserted in the graphite mold was subjected to deoiling treatment in a reduced-pressure atmosphere. A rotary pump was used as an evacuation pump, and the shaped body was heated from room temperature to 100° C. at a temperature rising speed of 0.91° C./min, and then held at 100° C. for 40 hour. Through this step, oil components such as orientation lubricant and plasticizer could be removed by volatilization.

### <Sintering>

After the decarbonization, the second shaped body was subjected to sintering in a reduced-pressure atmosphere. This sintering was performed under the condition that the second shaped body set in the graphite die is heated up to 700° C. at a temperature rising speed of 27° C./min while being applied with a pressing pressure of 2.4 MPa in the length direction as an initial load, then the second shaped body is heated up to 950° C. at a temperature rising speed of 7.1° C./min under a pressing pressure of 12 MPa, and then held at 950° C. for 5 minutes. After the sintering, an obtained sintered body was cooled to room temperature.

### Examples 16 and 17

Except that after the magnetic field orientation, the formation of a second shaped body was performed, and the above conditions were changed to those in Table 5, sintered bodies in Examples 16 and 17 were obtained in the same manner as that in Example 1. A first shaped body was formed in the same manner as that in Example 15, and a magnetic field was applied in the direction indicated in FIG. 7(a). The first shaped bodies in Examples 16 and 17 are different in thickness.

### <Formation of Second Shaped Body>

The first shaped body after being subjected to the demagnetization treatment was taken out of the stainless steel die, and put in a negative die having a cavity in which a curvature radius of a portion thereof corresponding to a part of the second surface of each of the end regions 7a, 8a is 50.00 mm. Then, the first shaped body was pressed and deformed by a positive die having a die surface in which a curvature radius of a region thereof corresponding to the first surface is 50.00 mm, to thereby form an intermediate shaped body. Subsequently, the intermediate shaped body was put in a negative die having a cavity corresponding to a second shaped body, and pressed and deformed by a positive die having a die surface corresponding to the first surface of the second shaped body, to thereby form the second shaped body. Both of the deformation to the intermediate shaped body and the deformation to the second shaped body were performed under a temperature condition of 60° C.

TABLE 5

| | | | Deoiling Step | | | Calcining Step | | | Sintering Step | | | | | |
|---|---|---|---|---|---|---|---|---|---|---|---|---|---|---|
| | Alloy | | | Tem- | Holding | | Tem- | Holding | Initial | | Load in | | Tem- | Holding |
| | Composition | Pulverization | Final | perature | Time | Final | perature | Time | Load | Temperature | range of | Final | perature | Time |
| Example | A | Ball | 100 | 0.7 | 40 | 370 | 2.9 | 2 | 2.4 | 27 | 12 | 950 | 7.1 | 5 |
| 15 | | mill | | | | | | | | | | | | |
| Example | B | Jet | — | — | — | 370 | 0.82 | 3 | 0 | 8 | 0 | 980 | 8 | 120 |
| 16 | | mill | | | | | | | | | | | | |
| Example | B | Jet | — | — | — | 370 | 0.82 | 3 | 0 | 8 | 0 | 980 | 8 | 120 |
| 17 | | mill | | | | | | | | | | | | |

TABLE 6

| | | Weight | | Weight | | Weight |
|---|---|---|---|---|---|---|
| | Polymer | Part | Orientation Lubricant | Part | Plasticizer | Part |
| Example 15 | PIB | 50 | 1-Octadecyne | 6.7 | — | — |
| | B150 | | | | | |
| | 8 wt % toluene solution | | | | | |
| Example 16 | PIB | 50 | Oleyl Alcohol | 0.8 | 1-Octadecene | 4.1 |
| | B100 | | | | | |
| | 10 wt % toluene | | | | | |
| | solution | | | | | |
| Example 17 | PIB | 50 | Oleyl Alcohol | 0.8 | 1-Octadecene | 4.1 |
| | B100 | | | | | |
| | 10 wt % toluene | | | | | |
| | solution | | | | | |

In Examples 15 to 17, an orientation axis angle was measured, in addition to the same evaluations as those in Example 1.

### <Measurement of Orientation Axis Angle and Orientation-Angle Variation>

A surface of the obtained sintered body was subjected to a surface treatment by SiC paper polishing, buffing and milling, and then the orientation of the sintered body was analyzed using an SEM (device name: JSM-7001F, manufactured by JEOL Ltd.) equipped with an EBSD detector (device name: AZtecHLK EBSD NordlysNano Integrated, manufacturing by Oxford Instruments plc), or an electron scanning microscope (SUPRA40VP manufactured by Zeiss) equipped with an EBSD detector manufactured by EDAX Inc., (Hikari High Speed EBSD Detector). The EBSD analysis was performed under the condition that the view angle is set to 35 μm, and the step is set to 0.2 μm. Further, in order to provide improved analytical accuracy, the analysis was performed under the condition that at least 30 sintered particles fall within the view angle. Analysis data was analyzed using Chanel 5 (manufactured by Oxford Instruments) or OIM analyzing software version 5.2 (manufactured by EDAX Inc.).

In Examples 15 to 17, a trapezoidal-shaped magnet as a sintered body was cut at the length-directional center thereof, and the cut surface was subjected to the measurement. The measurement and analysis was performed at three points adjacent to left and right ends and a center of the trapezoidal cut surface on a horizontal line passing through a thickness-directional center of the cut surface.

In each of the analytical points, a direction along which the easy magnetization axes are most frequently directed is defined as an orientation axis direction at the analytical point, and an angle of the orientation axis direction with respect to a reference plane is defined as an orientation axis angle. As depicted in FIG. 16(a), assuming that a bottom surface of a truncated pyramid is a plane including an A2-axis direction and an A3-axis direction, a deviation angle α of an orientation axis from the A1-axis toward the A3-axis direction and a deviation angle β of an orientation axis from the A1-axis toward the A2-axis direction are calculated as the orientation angle. Further, in the analytical points, an angle between two of the orientation axis angles having the largest angular difference is derived to calculate an orientation-angle variation φ(0°≤φ≤90°).

In each EBSD analysis, after correcting the orientation axis direction to 0°, an angular difference Δθ between the 0° direction and the orientation axis direction of the easy magnetization axis of each crystal particle was calculated per pixel (0°≤Δθ≤90°), and a cumulative percentage obtained by integrating the frequencies of the angular difference Δθ with respect to each of the angles from 90° to 0°, and an angle corresponding to a cumulative percentage of 50% is derived as an orientation-angle variation (half width of Δθ distribution).

Results of the analysis are presented in Table 7.

TABLE 7

| | | | | | | | | Orientation Angle | | |
|---|---|---|---|---|---|---|---|---|---|---|
| | | | | | | | | Variation | | |
| | Orientation Axis Angle | | | | | | | Half width of [symbol] θ | | |
| | | | | | Right | | | distribution (°) | | |
| | Left End | | Central | | End | | Orientation | Left | | Right |
| | Region | | Region | | Region | | Axis | End | Central | End |
| | α (°) | β (°) | α (°) | β (°) | α (°) | β (°) | (°) | Region | Region | Region |
| Example 15 | 0 | 27 | 0 | 0 | 0 | −30 | 57 | 22.6 | 23.4 | 22.5 |
| Example 16 | 0 | 25 | −3 | −5 | −3 | −22 | 47 | 12.3 | 11.3 | 10.3 |
| Example 17 | −5 | 21 | −3 | 2 | −3 | −17 | 38 | 12.1 | 10.6 | 11 |

| | Sintered | Aspect | | | | |
|---|---|---|---|---|---|---|
| | Particle | Ratio of | Carbon | Oxygen | Hydraugen | Nitogen |
| | Size | Sintered | Content | Content | Content | Content |
| | (um) | Particle | (ppm) | (ppm) | (ppm) | (ppm) |
| Example 15 | 1 | 1.6 | 170 | 1500 | 300 | 250 |
| Example 16 | 0.9 | 1.6 | 430 | 4200 | 900 | 300 |
| Example 17 | 0.9 | 1.6 | 500 | 3600 | 800 | 250 |

In each of Examples 15 to 17, it could be ascertained that the carbon content of the sintered body for forming a rare-earth magnet is 500 ppm or less, and the average particle size of the magnet material particles is 2 μm or less, wherein the easy magnetization axes of the magnet material particles in each of a plurality of regions of the sintered body are oriented in a respective one of a plurality of different directions, specifically, the angle φ between two of respective orientation vectors at the analytical points is at least 20° or more, i.e., the easy magnetization axes does not have not a parallel orientation, and a value of the half width of the Δθ distribution, i.e., an index of the orientation-angle variation at each analytical point, is in the range of about 10 to 24°, so that despite being a non-parallel magnet, it can be obtained with less variation.

### LIST OF REFERENCE SIGNS

1: rare-earth permanent magnet-forming sintered body
2: upper side
3: lower side
4, 5: end face
6: central region
7, 8: end region
20: electric motor
21: rotor core
21a: outer peripheral surface
22: air gap
23: stator
23a: teeth
23b: field coil
24: magnet-insertion slot
24a: linear central section
24b: inclined section
30: rare-earth magnet
117: composite material
118: support substrate
119: green sheet
120: slot-die
123: processing sheet piece
125: sintering sheet piece
C: easy magnetization axis
θ: inclination angle

1. A sintered body for forming a rare-earth magnet comprising a large number of magnet material particles sintered together, each of the magnet material particles containing a rare-earth substance and having an easy magnetization axis, wherein
the sintered body for forming a rare-earth magnet has a carbon content of 500 ppm or less; and
the magnet material particles have an average particle size of 2 μm or less.

2. The sintered body for forming a rare-earth magnet as recited in claim 1, wherein the magnet material particles have an aspect ratio of 2 or less.

3. The sintered body for forming a rare-earth magnet as recited in claim 1, wherein the sintered body for forming a rare-earth magnet has a unitary sintered structure, and wherein the easy magnetization axes of the magnet material particles in arbitrary plural number of regions of the sintered structure are oriented in different directions respectively.

4. A sintered body for forming a rare-earth magnet comprising a number of magnet material particles sintered together, each of the magnet material particles containing a rare-earth substance and having an easy magnetization axis, wherein:
the sintered body for forming a rare-earth magnet has a unitary sintered structure, wherein the easy magnetization axes of the magnet material particles in arbitrary plural number of regions of the sintered structure are oriented in different directions respectively; and
the sintered body for forming a rare-earth magnet has a carbon content of 500 ppm or less.

5. A sintered body for forming a rare-earth magnet comprising a number of magnet material particles sintered together, each of the magnet material particles containing a rare-earth substance and having an easy magnetization axis, wherein:
the sintered body for forming a rare-earth magnet has a unitary sintered structure, wherein the easy magnetization axes of the magnet material particles in arbitrary plural number of regions of the sintered structure are oriented in different directions respectively; and
the magnet material particles have an average particle size of 2 μm or less.

6. The sintered body for forming a rare-earth magnet as recited in claim 4, wherein the magnet material particles have an aspect ratio of 2 or less.

7. A rare-earth magnet formed by magnetizing the sintered body for forming a rare-earth magnet as recited in claim 1.
